(19) United States
(12) Patent Application Publication
(10) Pub. No.: US 2024/0286034 A1
(43) Pub. Date: Aug. 29, 2024

(54) NON-TRANSITORY COMPUTER READABLE MEDIUM, INFORMATION PROCESSING METHOD, AND INFORMATION PROCESSING SYSTEM

(71) Applicant: CYGAMES, INC., Tokyo (JP)

(72) Inventors: Dai Kikuchi, Tokyo (JP); Ryo Kato, Tokyo (JP); Yuka Tanaka, Tokyo (JP); Tomonori Suzuki, Tokyo (JP)

(73) Assignee: CYGAMES, INC., Tokyo (JP)

(21) Appl. No.: 18/658,573

(22) Filed: May 8, 2024

Related U.S. Application Data
(63) Continuation of application No. PCT/JP2022/041979, filed on Nov. 10, 2022.

(30) Foreign Application Priority Data
Nov. 11, 2021 (JP) 2021-183795
Nov. 11, 2021 (JP) 2021-183796

(51) Int. Cl. A63F 13/45; A63F 13/69; A63F 13/79

(52) U.S. Cl. CPC A63F 13/45; A63F 13/69; A63F 13/79

(57) ABSTRACT

A non-transitory computer readable medium stores a program causing a computer to execute: a process for deciding one item of content from a plurality of kinds of content; a process for playing back the decided content; a process for deciding a display pattern of an object associated with the content that is played back; and a process for displaying the object in the decided display pattern at least one of during playback of the content and in a state in which the content that is played back is decided.

### CROSS REFERENCE TO RELATED APPLICATIONS

This application is a continuation application of International Application No. PCT/JP2022/041979, filed on Nov. 10, 2022, which claims priority to Japanese Patent Application Nos. 2021-183795 and 2021-183796, each filed on Nov. 11, 2021, the entire contents of which are incorporated by reference herein.

### BACKGROUND ART

### Technical Field

The present invention relates to information processing programs, information processing methods, and information processing systems.

As indicated in PTL 1, there are well-known games provided with a jukebox function for playing back content, such as music and movies, selected by players.

### CITATION LIST

### Patent Literature

Patent Literature 1: JP 2012-513283 A

### SUMMARY OF INVENTION

### Technical Problem

There are games provided with a jukebox function for allowing playback of content that is output in various scenes in the games. In such a game, the jukebox function is positioned as an additional service and remains to be improved in order to further motivate players to play the game.

An object of the present invention is to provide an information processing program, an information processing method, and an information processing system capable of further motivating a player to play a game.

### Solution to Problem

In order to solve the aforementioned problem, an information processing program causes a computer to execute: a process for deciding one item of content from a plurality of kinds of content; a process for playing back the decided content; a process for deciding a display pattern of an object associated with the content that is played back; and a process for displaying the object in the decided display pattern at least either during playback of the content or in a state in which the content that is played back is decided.

The process for deciding one item of content may include a process for deciding the one item of content by lottery regardless of an operation input made by a player.

The object may be a character, and a display mode of the character may differ depending on the decided display pattern.

The information processing program may cause the computer to further execute a process for enabling a player to evaluate the content that is played back.

In order to solve the aforementioned problem, an information processing method executed by a computer includes: a process for deciding one item of content from a plurality of kinds of content; a process for playing back the decided content; a process for deciding a display pattern of an object associated with the content that is played back; and a process for displaying the object in the decided display pattern at least either during playback of the content or in a state in which the content that is played back is decided.

In order to solve the aforementioned problem, an information processing system includes at least one computer, and the computer executes: a process for deciding one item of content from a plurality of kinds of content; a process for playing back the decided content; a process for deciding a display pattern of an object associated with the content that is played back; and a process for displaying the object in the decided display pattern at least either during playback of the content or in a state in which the content that is played back is decided.

### Effects of Disclosure

The present invention can further motivate a player to play a game.

### BRIEF DESCRIPTION OF DRAWINGS

FIG. 1 is an illustration showing a schematic configuration of an information processing system.

FIG. 2A is a drawing for illustrating the hardware configuration of a player terminal.

FIG. 2B is a drawing for illustrating the hardware configuration of a server.

FIG. 3A is a drawing for illustrating an example of a home screen.

FIG. 3B is a drawing for illustrating an example of an option setting screen.

FIG. 3C is a drawing for illustrating an example of a profile setting screen.

FIG. 3D is a drawing for illustrating an example of a music playback condition setting screen.

FIG. 4A is a drawing for illustrating an example of a home left screen.

FIG. 4B is a drawing for illustrating an example of a home right screen.

FIG. 4C is a drawing for illustrating an example of a home setting screen.

FIG. 5A is a drawing for illustrating an example of a music selection screen.

FIG. 5B is a drawing for illustrating an example of a music-in-selection information screen.

FIG. 5C is a drawing for illustrating an example of an evaluation history information screen.

FIG. 5D is a drawing for illustrating an example of a playback history information screen.

FIG. 6A is a drawing for illustrating an example of the home screen when a random music selection function is invoked.

FIG. 6B is a drawing for illustrating an example of the home right screen when the random music selection function is invoked.

FIG. 6C is a drawing for illustrating an example of a requester details screen.

FIG. 6D is a drawing for illustrating an example of the music-in-selection information screen when the random music selection function is invoked.

FIG. 7A is a drawing for illustrating an example of the evaluation history information screen when an other-player-request function is invoked.

FIG. 7B is a drawing for illustrating an example of the evaluation history information screen when a player evaluates a music piece.

FIG. 8 is a diagram for illustrating the configuration of a memory in the player terminal and functions of the player terminal as a computer.

FIG. 9 is a diagram for illustrating the configuration of a memory in the server and functions of the server as a computer.

FIG. 10 is a sequence diagram for illustrating basic processes of the player terminal and the server.

FIG. 11 is a flowchart for illustrating an at-login music playback process in the player terminal.

FIG. 12 is a flowchart for illustrating a top screen transition process in the player terminal.

FIG. 13 is a flowchart for illustrating an evaluation information update process in the player terminal.

FIG. 14 is a flowchart for illustrating a music selection process in the server.

FIG. 15 is a drawing for illustrating music classifications and music release information.

FIG. 16 is a flowchart for illustrating a character request music decision process in the server.

FIG. 17 is a flowchart for illustrating a presentation process in the player terminal.

FIG. 18 is a flowchart for illustrating a friend presentation decision process in the player terminal.

FIG. 19 is a drawing for illustrating melody tags.

FIG. 20A is a drawing for illustrating the relationship between melody tags and movement patterns of a mini-character.

FIG. 20B is a drawing for illustrating the relationship between melody tags and a mini-jukebox image.

FIG. 21 is a flowchart for illustrating a character request presentation decision process in the player terminal.

FIG. 22 is a drawing for illustrating the relationship among music IDs, character IDs, and comment IDs.

FIG. 23 is a drawing for illustrating comment-attached normal music pieces.

FIG. 24 is a drawing for illustrating character-specific melody tag information.

FIG. 25 is a drawing for illustrating generic comment information.

FIG. 26 is a flowchart for illustrating an evaluation information decision process in the player terminal.

FIG. 27 is a drawing for illustrating character correlation information.

FIG. 28 is a sequence diagram for illustrating processes executed in the player terminal and the server when a player selects a music piece to be played back.

FIG. 29 is a first flowchart for illustrating a jukebox process in the player terminal.

FIG. 30 is a second flowchart for illustrating the jukebox process in the player terminal.

### DESCRIPTION OF EMBODIMENTS

An aspect of an embodiment of the present invention will be described below in detail with reference to the accompanying drawings. Numerical values, etc. given in this embodiment are merely examples for facilitating understanding, and do not limit the present invention unless otherwise specifically mentioned. In this description and the drawings, the same reference signs are attached to elements having substantially the same functions and configurations, omitting repeated descriptions thereof, and elements that are not directly related to the present invention are not shown.

### (Overall Configuration of Information Processing System S)

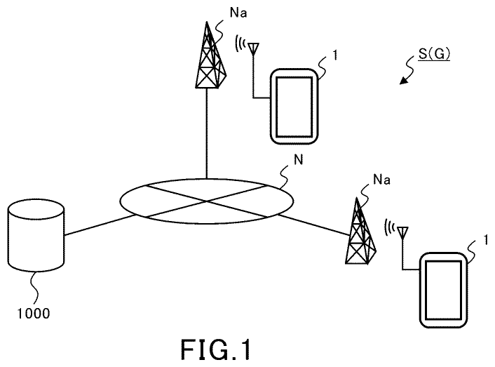

FIG. 1 is an illustration showing a schematic configuration of an information processing system S. The information processing system S is what is called a client-server system, including player terminals 1 functioning as clients (i.e., game terminals), a server 1000, and a communication network N having communication base stations Na.

In the information processing system S according to this embodiment, the player terminals 1 and the server 1000 each function as a game device G. The player terminals 1 and the server 1000 individually have assigned thereto roles for controlling the proceeding of the game such that it is possible to proceed with the game through cooperation between the player terminals 1 and the server 1000.

Each of the player terminals 1 can establish communication with the server 1000 via the communication network N. The player terminals 1 widely include electronic appliances that can be communicatively connected to the server 1000 by wire or wirelessly. Examples of the player terminals 1 include smartphones, mobile phones, tablet devices, personal computers, and game devices. This embodiment will be described by way of an example where each of the player terminals 1 is a smartphone having a game application downloaded thereinto.

The server 1000 is communicatively connected to the plurality of player terminals 1. The server 1000 accumulates various kinds of information for each player who plays a game. Furthermore, mainly on the basis of operations input from the player terminals 1, the server 1000 executes processes, such as updating the accumulated information and causing the player terminals 1 to download images and various kinds of information.

The communication base stations Na are connected to the communication network N, and transmits information to and receives information from the player terminals 1 wirelessly. The communication network N is configured of a mobile phone network, the Internet, a local area network (LAN), a dedicated circuit, etc., and realizes wired or wireless communicative connection between the player terminals 1 and the server 1000.

### (Hardware Configuration of Player Terminal 1 and Server 1000)

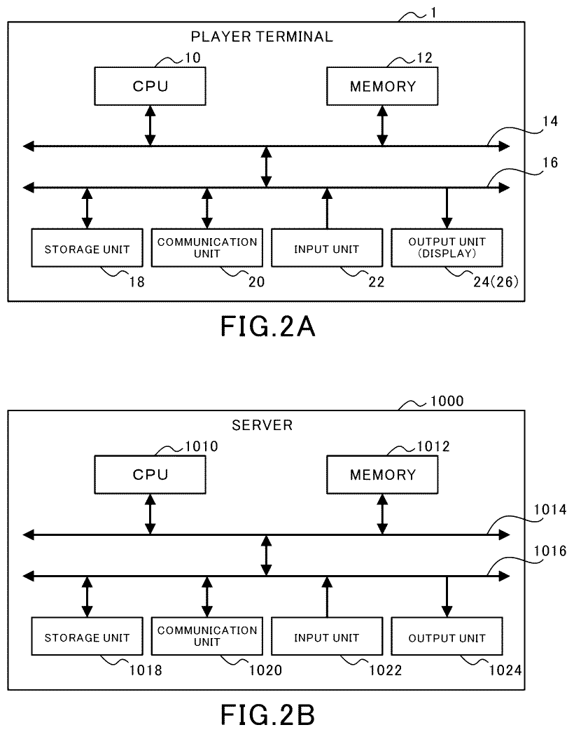

FIG. 2A is a drawing for illustrating the hardware configuration of a player terminal 1. In addition, FIG. 2B is a drawing for illustrating the hardware configuration of the server 1000. As shown in FIG. 2A, the player terminal 1 is configured to include a central processing unit (CPU) 10, a memory 12, a bus 14, an input/output interface 16, a storage unit 18, a communication unit 20, an input unit 22, and an output unit 24.

Furthermore, as shown in FIG. 2B, the server 1000 is configured to include a CPU 1010, a memory 1012, a bus 1014, an input/output interface 1016, a storage unit 1018, a communication unit 1020, an input unit 1022, and an output unit 1024.

Note that the configurations and functions of the CPU 1010, the memory 1012, the bus 1014, the input/output interface 1016, the storage unit 1018, the communication unit 1020, the input unit 1022, and the output unit 1024 of the server 1000 are substantially the same as those of the CPU 10, the memory 12, the bus 14, the input/output interface 16, the storage unit 18, the communication unit 20, the input unit 22, and the output unit 24, respectively, of the player terminal 1. Thus, a description of the hardware configuration of the player terminal 1 will be given below, and a description of the server 1000 will be omitted.

The CPU 10 runs a program stored in the memory 12 to control the proceeding of the game. The memory 12 is configured of a read only memory (ROM) or a random access memory (RAM), and stores the program and various kinds of data needed for controlling the proceeding of the game. The memory 12 is connected to the CPU 10 via the bus 14.

The input/output interface 16 is connected to the bus 14. The storage unit 18, the communication unit 20, the input unit 22, and the output unit 24 are connected to the input/output interface 16.

The storage unit 18 is configured of a semiconductor memory, such as a dynamic random access memory (DRAM), and stores various kinds of programs and data. At the player terminal 1, the programs and data stored in the storage unit 18 are loaded into the memory 12 (RAM) by the CPU 10.

The communication unit 20 is communicatively connected to a communication base station Na wirelessly, and transmits/receives information, such as various kinds of data and programs, to/from the server 1000 via the communication network N. At the player terminal 1, the programs, etc. received from the server 1000 are stored in the memory 12 or the storage unit 18.

The input unit 22 is configured of, for example, a touchscreen, buttons, a keyboard, a mouse, a cross key, or an analog controller with which player operations are input (operations are accepted). Alternatively, the input unit 22 may be a special controller provided in the player terminal 1 or connected (externally attached) to the player terminal 1. Yet alternatively, the input unit 22 may be configured of an acceleration sensor that detects tilting or movement of the player terminal 1 or a microphone that detects speech of the player. That is, the input unit 22 may widely include devices that enable the player to input his or her intents in distinguishable manners.

The output unit 24 is configured to include a display device and a speaker. The output unit 24 may be a device connected (externally attached) to the player terminal 1. In this embodiment, the player terminal 1 is provided with a display 26 as the output unit 24 and is provided with a touchscreen as the input unit 22, wherein the touchscreen is overlaid on the display 26.

### (Game Specifics)

Next, a game provided by the information processing system S and a game device G according to this embodiment will be described. A player can possess characters earned by lottery, which is a so-called gacha, or characters distributed by the game administrator. Furthermore, a player can possess support cards earned by lottery, which is a so-called gacha, or support cards distributed by the game administrator.

Although not described in detail, a nurturing game is provided in the game according to this embodiment. A player can nurture a character possessed by the player in the nurturing game. In addition, the nurturing game according to this embodiment has gameplay in which the player nurtures a character by making the character participate in a race simulating a horse race.

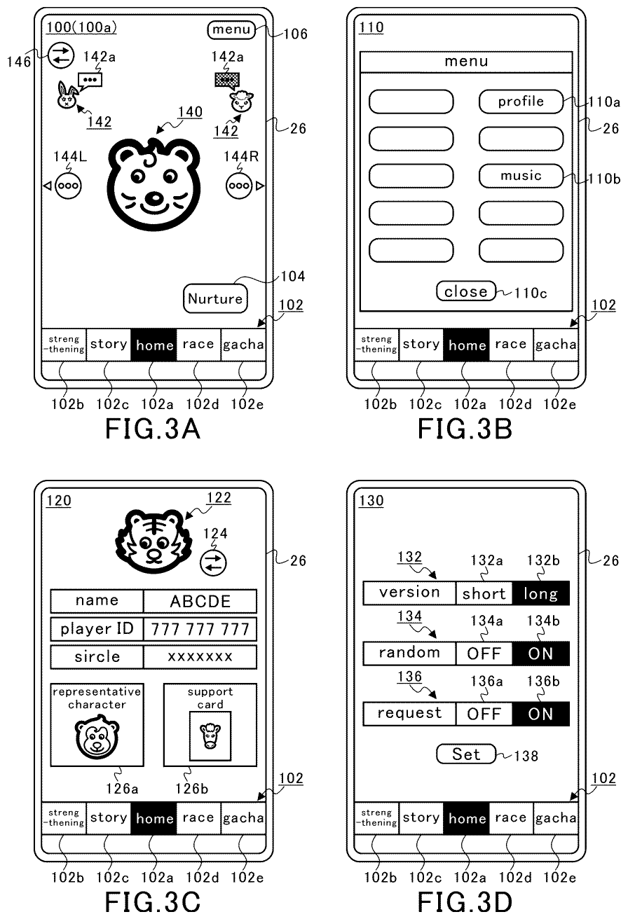

FIG. 3A is a drawing for illustrating an example of a home screen 100. When the game application is started at the player terminal 1, the home screen 100 is displayed on the display 26. In the lower section of the home screen 100, a menu bar 102 is displayed. A plurality of operation sections that can be operated (tapped) by the player are provided in the menu bar 102.

Here, a home screen selection operation section 102a, a strengthening screen selection operation section 102b, a story screen selection operation section 102c, a team stadium screen selection operation section 102d, and a gacha screen selection operation section 102e are provided in the menu bar 102. Note that in the menu bar 102, the operation section corresponding to the screen being displayed on the display 26 is highlighted so that the screen being displayed can be identified.

When the home screen selection operation section 102a is tapped, the home screen 100 shown in FIG. 3A is displayed on the display 26.

When the strengthening screen selection operation section 102b is tapped, a strengthening screen (not shown in the figure) is displayed. On the strengthening screen, it is possible to strengthen characters and support cards possessed by the player. The player can enhance the levels set to characters and support cards by strengthening the characters and the support cards. Characters and support cards have various kinds of parameters set thereto, so that the parameters increase as the levels increase. As a result of the parameters of a character and a support card increasing, the player can nurture a character having a more powerful status in the nurturing game.

When the story screen selection operation section 102c is tapped, a story screen (not shown in the figure) is displayed. Here, each of the characters appearing in the game is provided with a story image. The player can select and view a character and a story image on the story screen.

When the team stadium screen selection operation section 102d is tapped, a team stadium screen (not shown in the figure) is displayed. On the team stadium screen, the player can organize a team with characters nurtured by himself/herself. In addition, on the team stadium screen, it is possible to play a team competition game in which a team organized by the player is made to battle against a team organized by another player selected by the computer. The team competition game has gameplay in which the player competes with other players for rankings.

When the gacha screen selection operation section 102e is tapped, a gacha screen (not shown in the figure) is displayed. On the gacha screen, the player can perform a so-called gacha lottery, in which a character and a support card can be earned by lottery by consuming in-game currency.

In addition, on the home screen 100, a nurturing game operation section 104 is provided above the menu bar 102. When the nurturing game operation section 104 is tapped, a nurturing game screen (not shown in the figure) is displayed. The nurturing game is roughly classified into a preparation stage and a nurturing stage, and the player first selects one of the characters possessed by himself/herself at the preparation stage to set the selected character as a character to be nurtured. At the preparation stage, the player also sets a support card to be used when nurturing the character to be nurtured.

When setting a character to be nurtured and a support card is completed, the preparation stage transitions to the nurturing stage, whereby a game for nurturing the character to be nurtured is started. The player can possess the character nurtured in the nurturing game as a nurtured character. As described above, the player can organize nurtured characters possessed by himself/herself into a team for use in the team competition game.

Thus, the main objects of the game according to this embodiment are to nurture nurtured characters in the nurturing game and increase the ranking in the team competition game by using the nurtured characters.

In addition, in this embodiment, a function for sharing information among a plurality of players and a function for sharing a nurtured character or a support card are provided. The player can set a nurtured character and a support card that can be used by other players in the nurturing game. More specifically, as shown in FIG. 3A, a setting operation section 106 is provided in the upper right section of the home screen 100. When the setting operation section 106 is tapped, an option setting screen 110 is displayed.

FIG. 3B is a drawing for illustrating an example of the option setting screen 110. The option setting screen 110 is a screen that allows various kinds of information to be confirmed and set. A plurality of operation sections are provided on the option setting screen 110, so that when an operation section is tapped, information corresponding to the operation section can be confirmed and set.

The operation sections on the option setting screen 110 include a profile setting operation section 110a, a music playback condition setting operation section 110b, and a close operation section 110c. When the close operation section 110c is tapped, the option setting screen 110 is closed, and the home screen 100 is displayed. When the profile setting operation section 110a is tapped, a profile setting screen 120 is displayed.

FIG. 3C is a drawing for illustrating an example of the profile setting screen 120. On the profile setting screen 120, the player can confirm and set his/her own profile information. The profile information includes a profile character, a player name, a player ID, a circle to which the player belongs, a representative character, and a rental card.

The profile character functions as a character that is displayed when information concerning the player is viewed by another player. For example, the profile character is displayed when a circle function, which is a place for sharing information with other players, is used. On the profile setting screen 120, a currently set profile character image 122 is displayed. A change button 124 is provided near the profile character image 122. When the change button 124 is tapped, a profile character change screen (not shown in the figure) is displayed. On the profile character change screen, the player can change the profile character.

The player name set by the player, the player ID assigned to the player, and the name of the circle to which the player belongs are also displayed on the profile setting screen 120. In addition, a representative character setting operation section 126a and a rental card setting operation section 126b are provided on the profile setting screen 120.

When the representative character setting operation section 126a is tapped, a representative character setting screen (not shown in the figure) is displayed. On the representative character setting screen, the player can set, as a representative character, any one of the nurtured characters nurtured by himself/herself. On the representative character setting operation section 126a, an icon image indicating the currently set representative character is displayed. Note that, as described above, the representative character becomes available in a nurturing game played by another player.

When the rental card setting operation section 126b is tapped, a rental card setting screen (not shown in the figure) is displayed. On the rental card setting screen, the player can set, as a rental card, any one of the support cards possessed by himself/herself. On the rental card setting operation section 126b, an icon image indicating the currently set rental card is displayed. Note that, as described above, the support card set as a rental card becomes available in a nurturing game played by another player.

Note that although not described in detail, when a setting of the profile information is changed on the profile setting screen 120, setting change information is transmitted to the server 1000. In the server 1000, profile information for each player is saved.

In addition, when the music playback condition setting operation section 110b is tapped on the option setting screen 110, a music playback condition setting screen 130 is displayed.

FIG. 3D is a drawing for illustrating an example of the music playback condition setting screen 130. Although described below in detail, a jukebox function is provided in this embodiment. Various character images are displayed during the game. For example, characters appear on various screens of the nurturing game screen or the team stadium screen, as well as on the story screen. In addition, the player can make various selections on screens constituting the nurturing game screen and the team stadium screen, and one screen transitions to another in response to an operation input made by the player. In addition, music pieces (content) are played back under various circumstances during the game. Music pieces played back during the game include those corresponding to a game type such as the nurturing game and the team competition game, those corresponding to characters displayed on game screens, and so on. By using the jukebox function, the player can listen to a music piece selected by the player from a plurality of music pieces prepared in advance. Moreover, the player can play the game while playing back the selected music piece as background music (BGM).

It should be noted, however, that only limited game screens allow playback of BGM by means of the jukebox function. For example, while the story screen, the nurturing game screen, or the team stadium screen is being displayed, BGM dedicated to the respective screens is output. Therefore, the music piece selected by the player is output as BGM only while a screen other than the story screen, the nurturing game screen, and the team stadium screen is being displayed. Hereinafter, a screen on which the music piece selected by the player is output as BGM may be referred to as a top screen.

A version setting operation section 132, a random music selection setting operation section 134, an other-player-request setting operation section 136, and a setting completion operation section 138 are provided on the music playback condition setting screen 130. The version setting operation section 132 includes a short version selection operation section 132a and a long version selection operation section 132b. Each music piece that can be played back by the jukebox function has a short version with a short playback time and a long version with a long playback time. By making an operation input to the version setting operation section 132, the player can select the version of the music piece to be played back.

More specifically, when the short version selection operation section 132a is tapped, the short version of the music piece is selected, and when the long version selection operation section 132b is tapped, the long version of the music piece is selected. While the short version is selected, the short version of music piece is played back, and while the long version is selected, the long version of music piece is played back.

The random music selection setting operation section 134 includes an off-operation section 134a and an on-operation section 134b. By making an operation input to the random music selection setting operation section 134, the player can switch between an on status and an off status of a random music selection function. Here, the random music selection function refers to a function for randomly deciding a music piece upon transition to the top screen during the game and then outputting the decided music piece as BGM.

The on status of the random music selection function is a status in which the random music selection function is enabled. By tapping the on-operation section 134b, the player can set the random music selection function to the on status. On the other hand, the off status of the random music selection function is a status in which the random music selection function is disabled. By tapping the off-operation section 134a, the player can set the random music selection function to the off status.

The other-player-request setting operation section 136 includes an off-operation section 136a and an on-operation section 136b. By making an operation input to the other-player-request setting operation section 136, the player can switch between an on status and an off status of an other-player-request function. Here, the other-player-request function is a function for outputting, as BGM at the player's own player terminal 1, a music piece selected and played back by the jukebox function at the player terminal 1 of another player. As a result of BGM being output by this other-player-request function, the player is given an impression of sharing the jukebox with the other player.

The on status of the other-player-request function is a status in which the other-player-request function is enabled. By tapping the on-operation section 136b, the player can set the other-player-request function to the on status. On the other hand, the off status of the other-player-request function is a status in which the other-player-request function is disabled. By tapping the off-operation section 136a, the player can set the other-player-request function to the off status.

Note that the player can set the other-player-request function to the on status only if the random music selection function is set to the on status. Therefore, in the case where the random music selection function is set to the on status, the player can set the other-player-request function to the on status or the off status. On the other hand, the same time the random music selection function is set to the off status as a result of the player tapping the off-operation section 134a, the other-player-request function is also set to the off status.

Therefore, the player can select and set one of the three statuses: both the random music selection function and the other-player-request function are in the on status; both the random music selection function and the other-player-request function are in the off status; and the random music selection function is in the on status, and the other-player-request function is in the off status.

The setting completion operation section 138 is enabled when settings are changed as a result of the player making an operation input to the version setting operation section 132, the random music selection setting operation section 134, and the other-player-request setting operation section 136. When the enabled setting completion operation section 138 is tapped, the changed statuses are stored, and the setting changes are completed. When the setting changes are completed, the music playback condition setting screen 130 is closed, and the option setting screen 110 is displayed. Also, when the setting changes are completed, setting change information indicating the changed statuses is transmitted to the server 1000. The statuses set by the player are saved in the server 1000.

Next, the home screen 100 will be described. The home screen 100 includes a home center screen 100a, a home left screen 100b, and a home right screen 100c. Upon transition to the home screen 100, the home center screen 100a shown in FIG. 3A is displayed on the display 26. A home screen setting character 140 set by the player is displayed on the home center screen 100a.

Although described below in detail, the player can set four home screen setting characters 140. One of the four home screen setting characters 140 is displayed on the home center screen 100a. When the home screen setting character 140 displayed on the home center screen 100a is tapped, a predetermined message voice is output.

A sub-character 142 decided by lottery is also displayed on the home center screen 100a. A balloon image 142a is displayed for the sub-character 142. When the sub-character 142 or the balloon image 142a is tapped, the sub-character 142 is displayed in a magnified manner with a predetermined message image.

Here, a background image (not shown in the figure) is displayed on the home screen 100. Here, because a character is nurtured through the nurturing game, a background image giving the impression, for example, that the character is situated in a school building is displayed in accordance with the game world. Therefore, as a result of the player tapping the home screen setting character 140 or the sub-character 142, the player is given an impression of having conversation with a character in the school building.

Note that when an operation section in the menu bar 102 or the nurturing game operation section 104 is tapped, a game screen corresponding to the tapped operation section is displayed, as described above. At least one operation section is provided on the top screen that is first displayed after each operation section has been tapped, so that when this operation section is tapped, the screen transitions to a game screen corresponding to the operation section. As the top screen transitions to each game screen, output of BGM provided for each game screen is started. In addition, one of the four home screen setting characters 140 is displayed as a background image on the top screen.

In addition, notification icons 144L and 144R are displayed on the home center screen 100a. The notification icons 144L and 144R notify whether or not new information can be confirmed on the home left screen 100b and the home right screen 100c, respectively. When a rightward swipe operation is input to the home center screen 100a, the home left screen 100b is displayed, and when a leftward swipe operation is input to the home center screen 100a, the home right screen 100c is displayed.

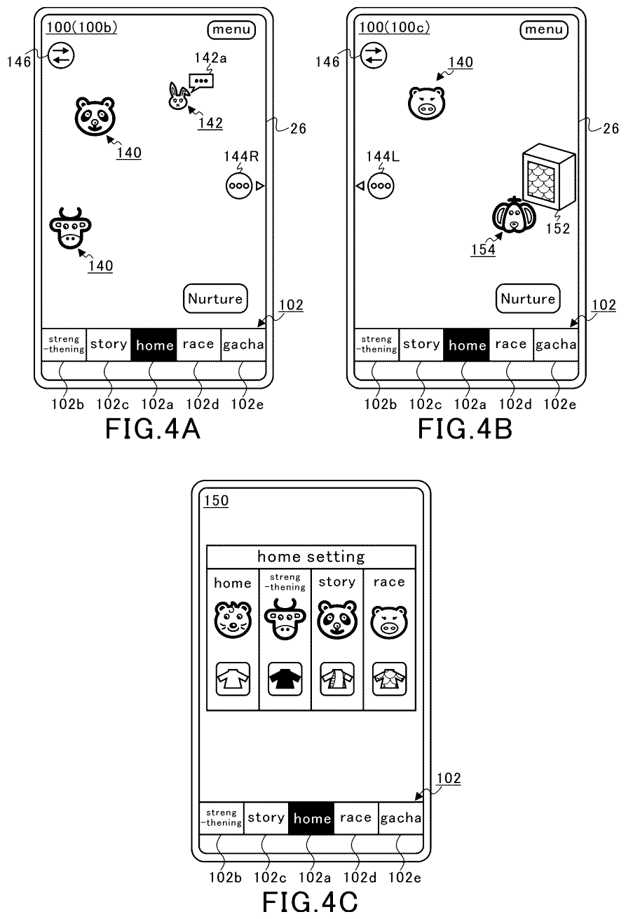

FIG. 4A is a drawing for illustrating an example of the home left screen 100b, and FIG. 4B is a drawing for illustrating an example of the home right screen 100c. As shown in FIG. 4A, two home screen setting characters 140, a sub-character 142, and the notification icon 144R are displayed on the home left screen 100b. When a leftward swipe operation is input to the home left screen 100b, the home center screen 100a is displayed.

In addition, as shown in FIG. 4B, one home screen setting character 140 and the notification icon 144L are displayed on the home right screen 100c. When a rightward swipe operation is input to the home right screen 100c, the home center screen 100a is displayed.

Here, the home screen setting characters 140 displayed on the home screen 100 function as operation sections for switching the screen. More specifically, the same function as that of the home screen selection operation section 102a is assigned to the home screen setting character 140 displayed on the home center screen 100a. In addition, the same functions as those of the strengthening screen selection operation section 102b and the story screen selection operation section 102c are assigned to the two respective home screen setting characters 140 displayed on the home left screen 100b. Furthermore, the same function as that of the team stadium screen selection operation section 102d is assigned to the home screen setting character 140 displayed on the home right screen 100c.

Therefore, when the home screen setting character 140 displayed in, for example, the upper left section of the home left screen 100b is tapped, the screen transitions from the home screen 100 to the story screen. Similarly, when the home screen setting character 140 displayed in the lower left section of the home left screen 100b is tapped, the screen transitions from the home screen 100 to the strengthening screen. Furthermore, when the home screen setting character 140 is tapped on the home right screen 100c, the screen transitions from the home screen 100 to the team stadium screen. Note that screen transition that occurs when a home screen setting character 140 is tapped is the same as when the menu bar 102 and the nurturing game operation section 104 are tapped. That is, when a home screen setting character 140 is tapped, the top screen corresponding to the home screen setting character 140 is displayed, and thereafter, on the basis of an operation input made by the player, the top screen transitions to each game screen, where output of BGM is started.

A setting icon 146 is displayed on the home screen 100. When the setting icon 146 is tapped, a home setting screen 150 is displayed.

FIG. 4C is a drawing for illustrating an example of the home setting screen 150. On the home setting screen 150, the player can set a home screen setting character 140 to be displayed on the home screen 100. In other words, the player can set a home screen setting character 140 assigned a function as an operation section.

As shown in FIG. 4C, character images corresponding to the four respective home screen setting characters 140 that are currently set, as well as corresponding operation sections, are displayed so as to be identifiable on the home setting screen 150. When a character image displayed on the home setting screen 150 is tapped, a character selection screen (not shown in the figure) is displayed. The player can select a home screen setting character 140 on the character selection screen. Also, the player can set costumes for the home screen setting characters 140 on the home setting screen 150.

In addition, as shown in FIG. 4B, a jukebox image 152 and a requesting character image 154 are displayed on the home right screen 100c. The jukebox image 152 functions as an operation section for accepting an operation for starting the jukebox function. The requesting character image 154 is displayed near the jukebox image 152 while a music piece is being played back by the jukebox function and in a state in which a music piece to be played back is decided.

Although described below in detail, when a music piece is to be played back by the jukebox function, a requester who has made a request for the music piece is always decided. The requester is a character. Hereinafter, a character serving as a requester is referred to as a requesting character. The requesting character image 154 corresponding to the requesting character is displayed near the jukebox image 152. This brings the impression that the requesting character is operating the jukebox. The jukebox function will be described below in detail.

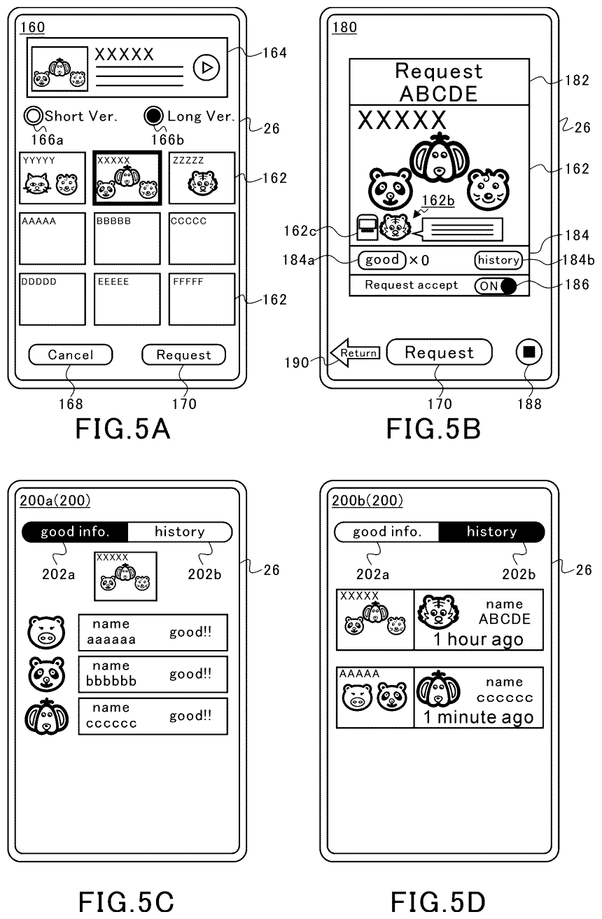

FIG. 5A is a drawing for illustrating an example of a music selection screen 160. The music selection screen 160 is a screen that allows the player to select a music piece to be played back while the player is playing the game. A plurality of jacket images 162 are displayed on the music selection screen 160. A jacket image 162 is provided for each music piece that can be played back by the jukebox function.

When any of the jacket images 162 is tapped, the tapped jacket image 162 is highlighted. At this time, the music piece corresponding to the tapped jacket image 162 is set as music-in-selection.

A music information display field 164 is provided in the upper section of the music selection screen 160. In the music information display field 164, music information tied to the current music-in-selection is displayed. The music information includes, for example, the name of the music piece, the jacket image 162, the name of the lyrist, the name of the composer, information concerning the music piece, etc. Note that when a jacket image 162 or the music information display field 164 is tapped, the music-in-selection may be played back so that the player can listen to it.

In addition, version switching toggles 166a and 166b are provided on the music selection screen 160. By tapping the version switching toggles 166a and 166b, the player can switch the version of the music piece to be played back, in the same manner as with the version setting operation section 132.

In addition, a cancel operation section 168 and a request operation section 170 are provided in the lower section of the music selection screen 160. When the cancel operation section 168 is tapped, the music selection screen 160 is hidden, and the previously displayed screen (music-in-selection information screen 180 described below) is displayed. Note that when the cancel operation section 168 is tapped after a change operation has been input as a result of a jacket image 162 or the version switching toggle 166a or 166b being tapped, the changed information is not saved but discarded.

When the request operation section 170 is tapped, a request playback status is switched. The request playback status identifies whether or not a music piece is being played back by the jukebox function. Here, the request playback status includes a playback-in-progress status indicating that a music piece is being played back and a stop status indicating that playback is stopped, i.e., no music pieces are being played back.

When the request operation section 170 is tapped in the playback-in-progress status, the request playback status changes from the playback-in-progress status to the stop status. In this case, the playback of the music-in-selection is stopped, and the music-in-selection information indicating the music-in-selection is eliminated. When the request operation section 170 is tapped in the stop status, music-in-selection information is stored, the request playback status changes from the stop status to the playback-in-progress status, and playback of the music-in-selection is started. At this time, the screen transitions from the music selection screen 160 to the music-in-selection information screen 180. Note that when the screen transitions from the music selection screen 160 to the music-in-selection information screen 180 as a result of the cancel operation section 168 being tapped, the request playback status may be changed to the playback-in-progress status.

Although not described in detail, default BGM, besides music pieces that can be played back by the jukebox function, is provided in this embodiment. In the stop status of the request playback status, the default BGM is output. It should be noted, however, that the player can set the sound volume of the BGM on the option setting screen 110. In a state in which the sound volume of the BGM is set to mute, the output of the default BGM is stopped.

FIG. 5B is a drawing for illustrating an example of the music-in-selection information screen 180. When the playback of the music-in-selection is started as a result of the request operation section 170 being tapped on the music selection screen 160, the music-in-selection information screen 180 in FIG. 5B is displayed. In addition, when the jukebox image 152 is tapped on the home screen 100, the music-in-selection information screen 180 shown in FIG. 5B is displayed. The jacket image 162, the request operation section 170, a requester name display field 182, an evaluation information display field 184, an other player request setting toggle 186, a playback stop button 188, and a return operation section 190 are provided on the music-in-selection information screen 180.

The jacket image 162 corresponding to the music piece being played back is displayed on the music-in-selection information screen 180. Note that when the jukebox image 152 is tapped on the home screen 100 while the default BGM is being output, a default image with no indication of a jacket image 162, etc. is displayed on the music-in-selection information screen 180. In addition, a presentation image 162b and a mini-jukebox image 162c are superimposed on the jacket image 162. The presentation image 162b includes a mini-character icon corresponding to the requester and a comment display field.

The mini-character icon moves in harmony with the rhythm of the music piece. In the case where the player has selected a music piece, the profile character set by the player is the requester. Therefore, in this case, a mini-character icon corresponding to the profile character is displayed. Note that in the case where the player has selected a music piece, the representative character set by the player may be the requester.

In addition, in the case where a music piece is selected by the random music selection function as described above (except for the case where the other-player-request function is invoked), a requesting character is decided. While a music piece selected by the random music selection function (except for the case where the other-player-request function is invoked) is being played back, a mini-character icon corresponding to the requesting character is displayed as the presentation image 162b.

In addition, in the case where a music piece is decided as a result of the other-player-request function being invoked, the representative character set by another player is decided to be the requester, i.e., the, requesting character. Therefore, in this case, the mini-character icon corresponding to the representative character of the other player is displayed as the presentation image 162b. Note that the profile character set by the other player may be decided to be the requesting character.

A comment corresponding to the music piece being played back is displayed in the comment display field. The mini-jukebox image 162c is provided with a plurality of display colors and is displayed in a color corresponding to the music piece being played back.

In addition, when the request operation section 170 is tapped on the music-in-selection information screen 180, the music selection screen 160 shown in in FIG. 5A is displayed. At this time, playback of the music-in-selection is stopped, and the music-in-selection information indicating the music-in-selection is eliminated.

The name of the requester is displayed in the requester name display field 182. In the case where the player selects a music piece, the player name set by the player is displayed in the requester name display field 182. In addition, while a music piece selected by the random music selection function (except for the case where the other-player-request function is invoked) is being played back, the character name of the requesting character is displayed. In addition, in the case where a music piece is decided as a result of the other-player-request function being invoked, the player name set by another player is displayed.

An evaluation operation section 184a and a history display button 184b are provided in the evaluation information display field 184. By tapping the evaluation operation section 184a, the player can evaluate the music piece being played back. In the evaluation information display field 184, the number of evaluations, indicating the number of evaluations carried out of the music piece being played back, is displayed next to the evaluation operation section 184a.

As shown in FIG. 5B, when playback of a music piece is started, the number of evaluations of the music piece is displayed as 0. When the player taps the evaluation operation section 184a in this state, the number of evaluations is updated to 1. In addition, the player can make only one evaluation of the music-in-selection during the period of time from when the music-in-selection is set to when the music-in-selection is changed. Therefore, once the evaluation operation section 184a is tapped by the player, it does not accept a subsequent operation.

When the history display button 184b is tapped, a history information screen 200 related to the music-in-selection is displayed.

FIG. 5C is a drawing for illustrating an example of an evaluation history information screen 200a, and FIG. 5D is a drawing for illustrating an example of a playback history information screen 200b. The history information screen 200 includes the evaluation history information screen 200a and the playback history information screen 200b. When the history display button 184b is tapped, the evaluation history information screen 200a shown in FIG. 5C is displayed. An evaluation history tab 202a and a playback history tab 202b are provided in the upper section of the history information screen 200.

Although described below in detail, a list of evaluators who have evaluated the music piece is displayed on the evaluation history information screen 200a, as shown in FIG. 5C. The history information of the music pieces played back by the jukebox function in the player terminal 1 is also displayed on the playback history information screen 200b, as shown in FIG. 5D. When the playback history tab 202b is tapped while the evaluation history information screen 200a is displayed, the playback history information screen 200b is displayed. In addition, when the evaluation history tab 202a is tapped while the playback history information screen 200b is displayed, the evaluation history information screen 200a is displayed.

In addition, by tapping the other player request setting toggle 186 on the music-in-selection information screen 180 shown in FIG. 5B, the player can switch between the on status and the off status of the random music selection function in the same manner as in the aforementioned random music selection setting operation section 134.

The playback stop button 188 functions as an operation section for switching between playback and stop of the music-in-selection. When the playback stop button 188 is tapped while the music-in-selection is being played back, the request playback status is switched to the stop status, and playback of the music piece is stopped. In this case, the music piece is placed into a pause status, with the music-in-selection information retained. In addition, when the playback stop button 188 is tapped while playback of the music-in-selection is stopped, the request playback status is switched to the playback-in-progress status, causing the music piece to be played back.

When the return operation section 190 is tapped on the music-in-selection information screen 180, the music-in-selection information screen 180 is hidden, and the home screen 100 is displayed. When the return operation section 190 is tapped while the music piece is being played back, playback of the music piece continues even after the home screen 100 is displayed. This allows the player to play the game while playing back, as BGM, the music piece he/she requested.

As described above, the jukebox function allows the player to select and listen to a favorite music piece. In addition, as described above, the random music selection function, which randomly decides a music piece upon transition to the top screen during the game and then outputs the decided music piece as BGM, is provided in this embodiment. The random music selection function will be described below in detail.

In this embodiment, there are invoking conditions for the random music selection function, so that a randomly selected music piece is played back as BGM when the invoking conditions are satisfied. Note that the invoking conditions for the random music selection function include: transition from the story screen, the nurturing game screen, or the team stadium screen to the top screen; the random music selection function being in the on status; an invoking time clock of the random music selection function having passed; and the request playback status being the playback-in-progress status.

When the invoking conditions are satisfied upon transition to the top screen, a music piece to be played back at the player terminal 1 is decided in the server 1000. Upon transition to the top screen, the player terminal 1 receives, from the server 1000, information concerning the music piece to be played back and plays back the music piece on the basis of the received information.

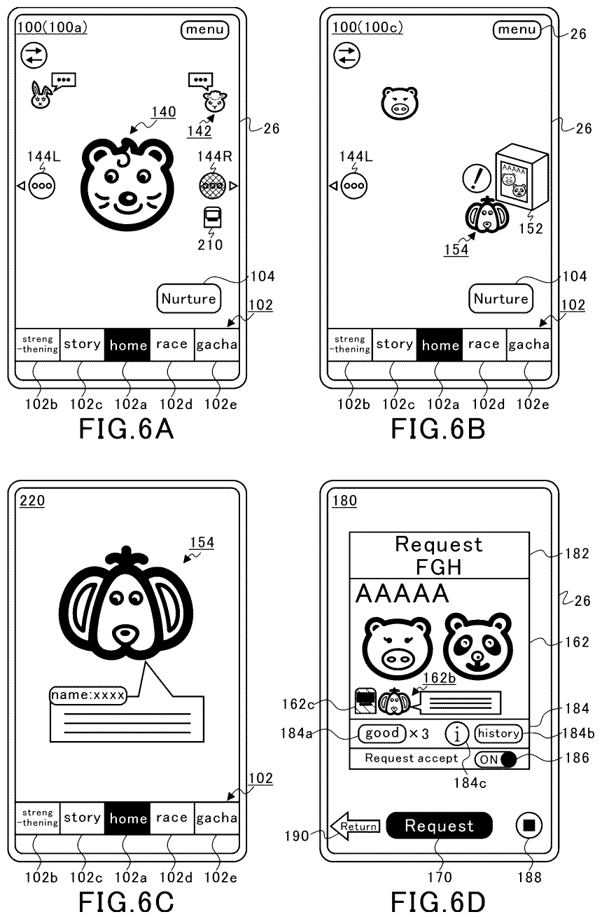

FIG. 6A is a drawing for illustrating an example of the home screen 100 when the random music selection function is invoked. For example, it is assumed that the music piece decided by the random music selection function is played back upon transition to the home center screen 100a. In this case, the home center screen 100a displays an image that prompts the player to confirm the home right screen 100c, more strictly, the jukebox image 152 displayed on the home right screen 100c.

More specifically, on the home center screen 100a, not only is the notification icon 144R highlighted but also a jukebox icon 210 is displayed near the notification icon 144R. The jukebox icon 210 is an image imitating a jukebox. As a result of the notification icon 144R being highlighted and the jukebox icon 210 being displayed, the player is prompted to make an operation input for displaying the home right screen 100c.

FIG. 6B is a drawing for illustrating an example of the home right screen 100c when the random music selection function is invoked. When a leftward swipe operation is input in the state shown in FIG. 6A, the home right screen 100c is displayed as shown in FIG. 6B. At this time, an image similar to the jacket image 162 corresponding to the music piece being played back is displayed on the jukebox image 152. This allows the player to identify the music piece being played back by the jukebox image 152.

In addition, as described above, when a music piece is decided by the random music selection function, the requester (requesting character) of the music piece is decided. The requesting character image 154 corresponding to the decided requesting character is displayed on the home right screen 100c. In addition, an icon with an exclamation mark is displayed near the requesting character image 154.

FIG. 6C is a drawing for illustrating an example of a requester details screen 220. When the requesting character image 154 is tapped on the home right screen 100c, the requester details screen 220 shown in FIG. 6C is displayed. The requesting character image 154, the name of the requester, and a comment are displayed on the requester details screen 220. Note that the comment displayed on the requester details screen 220 may be one tied to the music piece being played back or one tied to the requesting character image 154. In addition, the comment displayed on the requester details screen 220 may be the same as or different from the comment displayed in the comment display field of the presentation image 162b.

FIG. 6D is a drawing for illustrating an example of the music-in-selection information screen 180 when the random music selection function is invoked. When the jukebox image 152 is tapped on the home right screen 100c shown in FIG. 6B, the music-in-selection information screen 180 shown in FIG. 6D is displayed. The basic configuration of the music-in-selection information screen 180 is the same for the case where the player himself/herself has selected a music piece and the case where the random music selection function is invoked.

It should be noted, however, that when the other-player-request function is invoked, an information notification icon 184c is displayed in the evaluation information display field 184 of the music-in-selection information screen 180. When the information notification icon 184c is tapped, an other-player information screen (not shown in the figure) is displayed. Information concerning another player who has made a request for the music piece being played back is displayed on the other-player information screen. The information concerning another player includes, for example, the player name of the other player, the representative character, the profile character, a message set by the other player, etc.

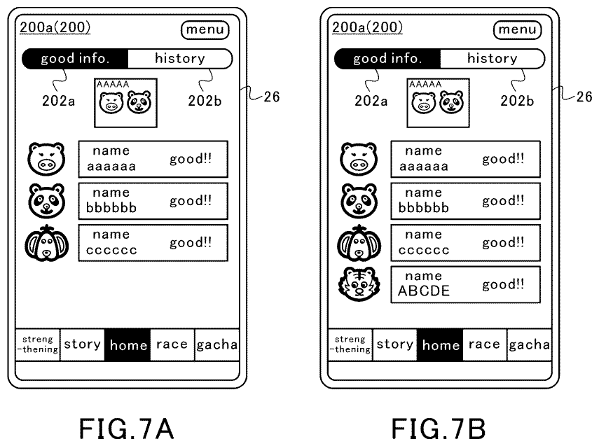

FIG. 7A is a drawing for illustrating an example of the evaluation history information screen 200a when the other-player-request function is invoked. FIG. 7B is a drawing for illustrating an example of the evaluation history information screen 200a when the player evaluates the music piece. When the other-player-request function is invoked, at least one evaluation is set the first time the music-in-selection information screen 180 is displayed.

For example, when another player himself/herself selects and plays back a music piece, an evaluator (evaluation character) is decided at the player terminal 1. In addition, when the player selects and plays back a music piece at the player terminal 1, the music piece selected by the player and evaluation information that is information indicating the evaluator are saved in the server 1000.

Also, the player can register other players as friends, and any one of the registered friends is decided in the other-player-request function. Then, the music piece last selected by the decided friend is played back at the player terminal 1.

At this time, the evaluation information tied to the music piece last selected by the friend is acquired, and the evaluation history information screen 200a is displayed on the basis of the acquired evaluation information, as shown in FIG. 7A. In addition, when the player taps the evaluation operation section 184a in this state, the evaluator is additionally displayed on the evaluation history information screen 200a, as shown in FIG. 7B. In this case, the information concerning the evaluator is transmitted to the server 1000, and the evaluation information tied to the music piece last selected by the friend is updated.

It is assumed that, thereafter, the same friend is decided to be the requester at the player terminal 1 of still another player. In this case, the evaluation history information screen 200a shown in in FIG. 7B is displayed from the beginning at the player terminal 1 of this other player.

Also it is assumed, for example, that at the player terminal 1 of the friend, the screen has transitioned to the nurturing game screen while the music piece selected by the friend is being played back, i.e., in the playback-in-progress status of the request playback status. Thereafter, when the nurturing game ends and the home screen 100 is displayed, the same music piece as before the start of the nurturing game is played back. At this time, it is assumed that the friend is decided to be the requester at the player terminal 1 of another player during the nurturing game of the friend, and the other player evaluates the music piece. In this case, the evaluation history information screen 200a in FIG. 7A is displayed at the player terminal 1 of the friend before the start of the nurturing game, but the evaluation history information screen 200a in FIG. 7B is displayed after the end of the nurturing game.

Thus, in this embodiment, various presentations are made when a music piece is played back by the jukebox function. Some of these presentations are shared among a plurality of players, giving an impression that the plurality of players use a single jukebox. That is, this embodiment gives an impression that a plurality of players are simultaneously playing a game, thus enhancing the player's motivation to play the game.

Next, functional configurations of the player terminal 1 and the server 1000 for realizing the aforementioned jukebox function, as well as processes executed by each of the player terminal 1 and the server 1000, will be described. Note that, of the functional configurations and processes provided in the game device G according to this embodiment, only portions related to the jukebox function will be described below.

### (Functional Configuration of Player Terminal 1)

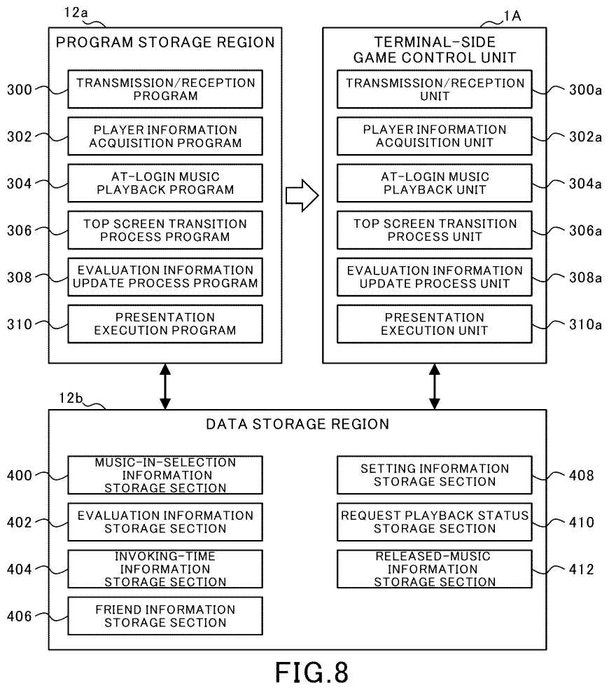

FIG. 8 is a diagram for illustrating the configuration of the memory 12 in the player terminal 1 and functions of the player terminal 1 as a computer. In the memory 12, a program storage region 12a and a data storage region 12b are provided. When the game is started, the CPU 10 stores terminal-side game control programs (modules) in the program storage region 12a.

The terminal-side game control programs include a transmission/reception program 300, a player information acquisition program 302, an at-login music playback program 304, a top screen transition process program 306, an evaluation information update process program 308, and a presentation execution program 310. Note that the programs listed in FIG. 8 are examples, and a large number of other programs are also provided as the terminal-side game control programs.

The data storage region 12b includes, as storage sections for storing data: a music-in-selection information storage section 400; an evaluation information storage section 402; an invoking-time information storage section 404; a friend information storage section 406; a setting information storage section 408; a request playback status storage section 410; a released-music information storage section 412; etc. Although here is listed only some of the typical storage sections for storing information concerning the jukebox function, a large number of other storage sections are provided in the data storage region 12b.

The CPU 10 runs the individual programs stored in the program storage region 12a and updates the data in the individual storage sections of the data storage region 12b. Furthermore, the CPU 10 runs the individual programs stored in the program storage region 12a, thereby causing the player terminal 1 (computer) to function as a terminal-side game control unit 1A. The terminal-side game control unit 1A includes a transmission/reception unit 300a, a player information acquisition unit 302a, an at-login music playback unit 304a, a top screen transition process unit 306a, an evaluation information update process unit 308a, and a presentation execution unit 310a.

More specifically, the CPU 10 runs the transmission/reception program 300, thereby causing the computer to function as the transmission/reception unit 300a. Similarly, the CPU 10 runs the player information acquisition program 302, the at-login music playback program 304, the top screen transition process program 306, the evaluation information update process program 308, and the presentation execution program 310, thereby causing the computer to function as the player information acquisition unit 302a, the at-login music playback unit 304a, the top screen transition process unit 306a, the evaluation information update process unit 308a, and the presentation execution unit 310a, respectively.

The transmission/reception unit 300a executes communication between the player terminal 1 and the server 1000, and transmits various kinds of information from the player terminal 1 to the server 1000. The transmission/reception unit 300a also downloads various kinds of information from the server 1000.

The player information acquisition unit 302a stores, in the data storage region 12b, information downloaded from the server 1000.

The at-login music playback unit 304a executes a process related to playback of BGM when a login process is executed at the player terminal 1.

The top screen transition process unit 306a executes a process related to playback of BGM upon transition to the top screen.

The evaluation information update process unit 308a updates the evaluation information.

The presentation execution unit 310a executes a process related to playback of a music piece and presentations during playback of the music piece.

### (Functional Configuration of Server 1000)

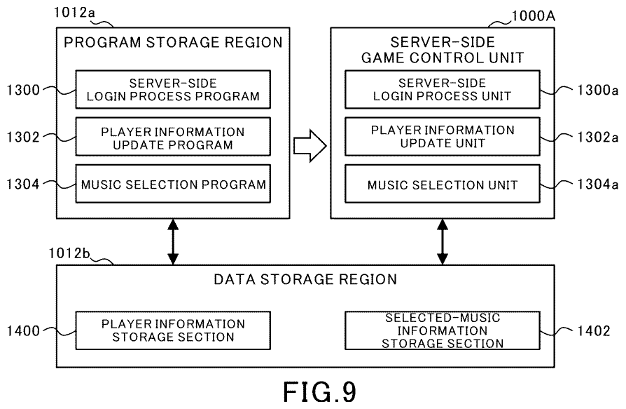

FIG. 9 is a diagram for illustrating the configuration of the memory 1012 in the server 1000 and functions of the server 1000 as a computer. In the memory 1012, a program storage region 1012a and a data storage region 1012b are provided. When the game is started, the CPU 1010 stores server-side game control programs (modules) in the program storage region 1012a.

The server-side game control programs include a server-side login process program 1300, a player information update program 1302, and a music selection program 1304. Note that the programs listed in FIG. 9 are examples, and a large number of other programs are also provided as the server-side game control programs.

The data storage region 1012b includes, as storage sections for storing data, a player information storage section 1400 and a selected-music information storage section 1402. Although here is listed only some of the typical storage sections for storing information concerning the jukebox function, a large number of other storage sections are provided in the data storage region 1012b. Here, all information stored in the data storage region 12b of the player terminal 1 are also stored in the data storage region 1012b of the server 1000. The various kinds of information stored in the data storage region 12b of the player terminal 1 are stored in the player information storage section 1400 of the server 1000.

The CPU 1010 runs the individual programs stored in the program storage region 1012a and updates the data in the individual storage sections of the data storage region 1012b. Furthermore, the CPU 1010 runs the individual programs stored in the program storage region 1012a, thereby causing the server 1000 to function as a server-side game control unit 1000A. The server-side game control unit 1000A includes a server-side login process unit 1300a, a player information update unit 1302a, and a music selection unit 1304a.

More specifically, the CPU 1010 runs the server-side login process program 1300, thereby causing the computer to function as the server-side login process unit 1300a. Similarly, the CPU 1010 runs the player information update program 1302 and the music selection program 1304, thereby causing the computer to function as the player information update unit 1302a and the music selection unit 1304a, respectively.

Upon receiving login information from the player terminal 1, the server-side login process unit 1300a causes various kinds of information stored in the player information storage section 1400 to be downloaded to the player terminal 1.

The player information update unit 1302a updates the player information in the player information storage section 1400 on the basis of the information received from the player terminal 1.

Upon invocation of the random music selection function, the music selection unit 1304a selects a music piece to be played back on the player terminal 1.

Processes executed by the individual functional units in the aforementioned player terminal 1 and server 1000 will be described below by using flowcharts.

### (Communication Processes Between Player Terminal 1 and Server 1000)

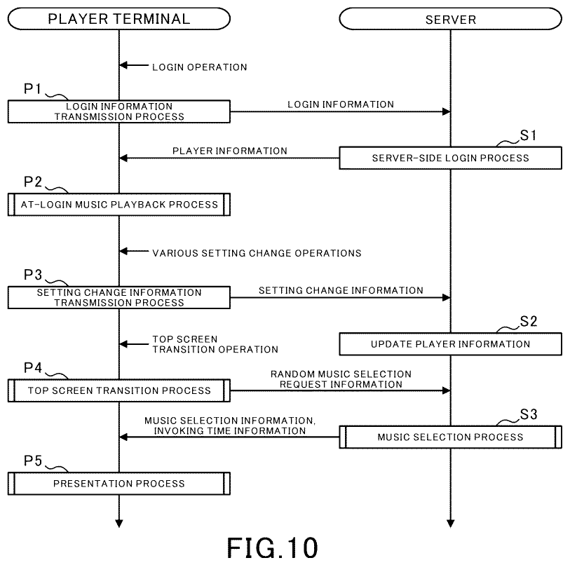

FIG. 10 is a sequence diagram for illustrating basic processes of the player terminal 1 and the server 1000. Note that, in the following description, processes in the player terminal 1 are denoted as Pn (n is any integer). In addition, processes in the server 1000 are denoted as Sn (n is any integer). Furthermore, processes in the player terminal 1 of a friend are denoted as Fn (n is any integer).

When the player performs a login operation, such as starting the game application, at the player terminal 1, a login information transmission process (P1) is executed. In the login information transmission process, the transmission/reception unit 300a transmits login information to the server 1000.

At the server 1000, upon receiving the login information, the server-side login process unit 1300a executes a server-side login process (S1). In the server-side login process, a process for causing the player terminal 1 to receive player information saved in the server 1000 is executed.

At the player terminal 1, upon receiving the player information from the server 1000, the player information acquisition unit 302a stores the received player information in the data storage region 12b. Also, the at-login music playback unit 304a executes an at-login music playback process (P2).

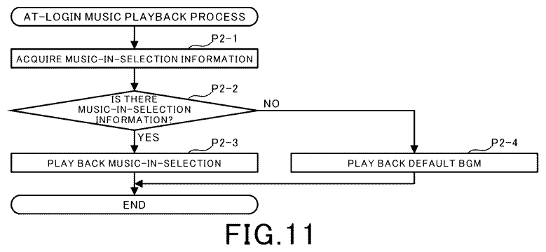

FIG. 11 is a flowchart for illustrating the at-login music playback process in the player terminal 1. The at-login music playback unit 304a acquires music-in-selection information stored in the music-in-selection information storage section 400 of the data storage region 12b (P2-1). Note that music-in-selection information is information for identifying a music piece to be played back by the jukebox function, such as a music ID provided for each music piece.

If music-in-selection information is stored (YES in P2-2), the at-login music playback unit 304a plays back the music-in-selection (P2-3). Because of this, if the game is interrupted while any music piece other than the default BGM is set as the music-in-selection, such as during playback of a music piece other than the default BGM, the music-in-selection that was set before the interruption of the game is played back when the game is restarted.

If no music-in-selection information is stored (NO in P2-2), the at-login music playback unit 304a plays back the default BGM (P2-4).

Referring back to FIG. 10, when the player performs various setting change operations to change settings on the option setting screen 110, etc., the information after the settings have been changed is stored in the setting information storage section 408. Also, the transmission/reception unit 300a transmits setting change information to the server 1000 (P3). At the server 1000, upon receiving the setting change information, the player information update unit 1302a updates the player information in the player information storage section 1400 (S2).

The player information stored in the server 1000 includes all information that is updated in the player terminal 1, such as information concerning characters possessed by the player, information concerning nurtured characters, information that can be set on the option setting screen 110, and information concerning the jukebox function.

When the player performs an operation for transition to the top screen, the top screen transition process unit 306a executes a top screen transition process (P4).

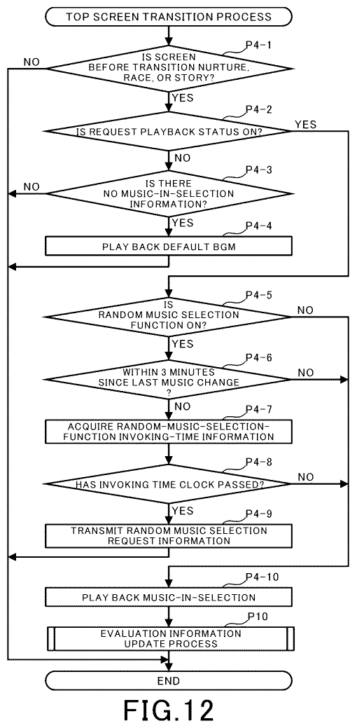

FIG. 12 is a flowchart for illustrating the top screen transition process in the player terminal 1. If the screen before transition to the top screen is the nurturing game screen, team stadium screen, or story screen (YES in P4-1), the request playback status is the off status (NO in P4-2), and no music-in-selection information is stored (YES in P4-3), then the top screen transition process unit 306a plays back the default BGM (P4-4). Note that it is determined in P4-1 whether the screen before transition to the top screen is the nurturing game screen, team stadium screen, or story screen, but the screen before transition to the top screen is not limited to these screens and can be any other game screen.

Also, if the request playback status is the on status (YES in P4-2), music-in-selection information is always stored. In this case, if the random music selection function is in the on status (YES in P4-5) and more than 3 minutes have passed since the last music change (NO in P4-6), then the top screen transition process unit 306a acquires random-music-selection-function invoking-time information stored in the invoking-time information storage section 404 (P4-7). The random-music-selection-function invoking-time information indicates the time clock at which invocation of the random music selection function is permitted (hereinafter, referred to as an “invoking time clock”).

Although described below in detail, when the random music selection function is invoked, a music piece to be played back is decided in the server 1000. At this time, an invoking time clock serving as the time clock when the next random music selection function can be invoked is decided in the server 1000. If the invoking time clock of the random music selection function has passed upon transition to the top screen (YES in P4-8), the top screen transition process unit 306a transmits random music selection request information to the server 1000 (P4-9).

That is, the random music selection request information is transmitted to the server 1000 if all the invoking conditions for the random music selection function are met in the top screen transition process. Although described below in detail, upon reception of the random music selection request information, one music piece is decided in the server 1000.

On the other hand, if at least one of the invoking conditions for the random music selection function is not met (NO in P4-5, YES in P4-6, or NO in P4-8), the top screen transition process unit 306a plays back the music-in-selection (P4-10). That is, if not all the invoking conditions for the random music selection function are met when the nurturing game screen, the team stadium screen, or the story screen transitions to the top screen, then the music-in-selection that was being played back before transition to the nurturing game screen, team stadium screen, or story screen is played back. In this case, the evaluation information update process unit 308a executes an evaluation information update process (P10).

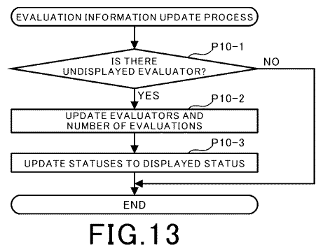

FIG. 13 is a flowchart for illustrating the evaluation information update process in the player terminal 1. The evaluation information update process unit 308a determines whether or not there is an undisplayed evaluator who is not displayed on the evaluation history information screen 200a (P10-1). Although described below in detail, when a music piece is played back on the player terminal 1, evaluators (evaluation characters) are decided in advance, and information identifying the evaluators is stored in the evaluation information storage section 402. In the evaluation information storage section 402, an undisplayed status or a displayed status is stored for each of the evaluators, and all evaluators are set to the undisplayed status when the evaluators are decided.

Also, when a music piece is first played back after the music piece has been decided, the pre-decided evaluators and the number of evaluations are not displayed in the evaluation information display field 184 and on the history information screen 200. Thereafter, if there is an evaluator whose status is the undisplayed status when the music-in-selection is to be played back after transition to the top screen (YES in P10-1), then the evaluation information update process unit 308a updates the evaluators on the history information screen 200 and the number of evaluations in the evaluation information display field 184 (P10-2). The evaluation information update process unit 308a also updates the statuses of the evaluators added to the history information screen 200 to the displayed status (P10-3).

Note that although the evaluation information update process is executed, the music-in-selection information screen 180 and the history information screen 200 are not displayed at this point of time because the home screen 100 is displayed on the display 26. The music-in-selection information screen 180 and the history information screen 200 are displayed when the player performs a predetermined operation input on the home screen 100.

Referring back to FIG. 10, when the random music selection request information is transmitted to the server 1000 in the top screen transition process (P4) of the player terminal 1, a music selection process (S3) is executed in the server 1000.

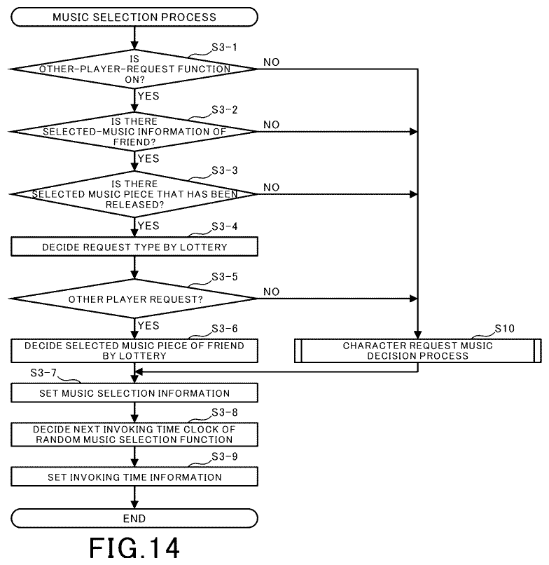

FIG. 14 is a flowchart for illustrating the music selection process in the server 1000. Upon receiving the random music selection request information, the music selection unit 1304a determines whether or not the other-player-request function is in the on status. If the other-player-request function is in the on status (YES in S3-1), the music selection unit 1304a further determines whether or not there is selected-music information of a friend (S3-2).

At the server 1000, when a player himself/herself selects and plays back a music piece, selected-music information in which the music piece played back is tied to the player is stored in the selected-music information storage section 1402. It should be noted, however, that in the selected-music information storage section 1402, only one item of latest selected-music information is stored for one player. It is assumed, for example, that a player having selected-music information stored in the selected-music information storage section 1402 newly plays back a music piece by using the jukebox function. In this case, the selected-music information stored in the selected-music information storage section 1402 is updated with information indicating the music piece newly played back. Note that no selected-music information is stored for players who have never selected and played back a music piece.

In addition, the player information storage section 1400 stores information concerning the players registered as friends by each player. Here, it is determined whether or not selected-music information of players registered as friends is stored in the selected-music information storage section 1402. Then, if selected-music information of a friend is stored (YES in S3-2), the music selection unit 1304a determines whether or not there is a selected music piece that has already been released (S3-3).

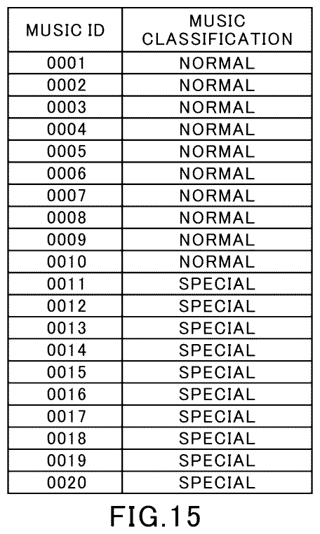

FIG. 15 is a drawing for illustrating music classifications and music release information. Music pieces that can be played back by the jukebox function are classified as either normal music pieces or special music pieces. Normal music pieces and special music pieces differ in the comments displayed on the presentation images 162b. In addition, while a normal music piece can be selected and played back by the player without any restrictions, a special music piece can be selected by the player only after it is selected as a result of the random music selection function being invoked.

Also, a normal music piece is presented with a jacket image 162 displayed on the music selection screen 160 from when the jukebox function is used for the first time. That is, a normal music piece is a music piece that the player can recognize as a music piece capable of being played back at the time the jukebox function is used for the first time. On the other hand, the jacket image 162 of a special music piece is not displayed on the music selection screen 160 until it is selected as a result of the random music selection function being invoked. That is, a special music can be considered as a so-called hidden music piece the existence of which cannot be recognized by the player until it is selected as a result of the random music selection function being invoked.

Once a special music piece is selected as a result of the random music selection function being invoked, the jacket image 162 of the special music piece is displayed on the music selection screen 160. Therefore, until selected once, a special music piece is set to an unreleased status (unreleased music piece) and cannot be selected by the player himself/herself. Also, once selected, the status of a special music piece is updated to a released status (released music piece), and thereafter, the player can freely select it by himself/herself in the same way as a normal music piece.

Thus, special music pieces are initially set as hidden music pieces and unreleased music pieces, while normal music pieces are set as released music pieces. Here, as an example, ten music pieces with music IDs 0001 to 0010 are provided as normal music pieces, and ten music pieces with music IDs 0011 to 0020 are provided as special music pieces.

Referring back to FIG. 14, if it is determined in S3-3 that there is a released one among the selected music pieces of the friends, the music selection unit 1304a decides a request type by lottery (S3-4). In this system, there are two request types: an other player request and a character request. The other player request invokes the other-player-request function, as described above, and decides a music piece selected by other players, i.e., friends. Therefore, if the request type is decided to be the other player request, the requester is one of the friends. In contrast, the character request is one that causes a music piece to be randomly decided by lottery. In this case, any one character is decided to be the requester.

In the lottery for deciding the request type in S3-4, the other player request is decided with, for example, a probability of 30% and the character request with a probability of 70%. If the other player request is decided in this lottery (YES in S3-5), the music selection unit 1304a decides one of the selected music pieces of the friends by lottery (S3-6). More specifically, the music selection unit 1304a extracts music pieces released for the player from the selected music pieces of the friends and decides one music piece from the extracted released music pieces by lottery.

That is, here, when the other-player-request function is invoked, only a music piece released for the player in question is decided to be the selected music piece. It should be noted, however, that even when the other-player-request function is invoked, an unreleased music piece may be decided.

On the other hand, if the other-player-request function is in the off status (NO in S3-1), if there is no selected-music information of the friends (NO in S3-2), if there are no music pieces released for the player in question among the selected music pieces of the friends (NO in S3-3), or if the request type is decided to be the character request (NO in S3-5), then the music selection unit 1304a executes a character request music decision process (S10).

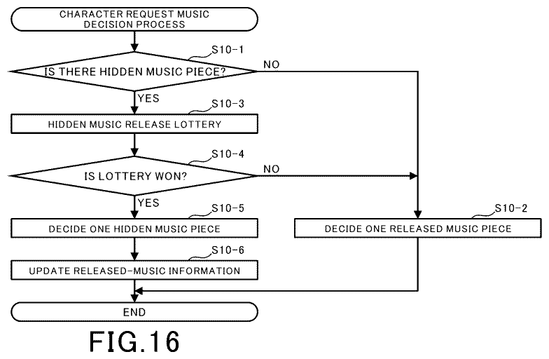

FIG. 16 is a flowchart for illustrating the character request music decision process in the server 1000. The music selection unit 1304a determines whether or not there is a hidden music piece (S10-1). If there are no hidden music pieces (NO in S10-1), the music selection unit 1304a decides one music piece among the released music pieces by lottery (S10-2). On the other hand, if there is a hidden music piece (YES in S10-1), the music selection unit 1304a executes a hidden music release lottery (S10-3). This hidden music release lottery is set, for example, with a 5% probability of winning. If the hidden music release lottery is not won (NO in S10-4), the music selection unit 1304a decides one released music piece in S10-2.

If the hidden music release lottery is won (YES in S10-4), the music selection unit 1304a decides one of the hidden music pieces (S10-5) and updates released-music information (S10-6). More specifically, the music selection unit 1304a updates the status of the decided hidden music piece from the unreleased status to the released status.

Referring back to FIG. 14, when a music piece is decided in S3-6 or S10, the music selection unit 1304a sets music selection information (S3-7) and causes the player terminal 1 to receive the music selection information. The music selection information set here includes the decided music ID and the request type. In addition, when a selected music piece of a friend is decided in S3-6, the music selection information includes profile information of the friend and evaluation information tied to the music ID.

In addition, the music selection unit 1304a decides the next invoking time clock of the random music selection function (S3-8). That is, the music selection unit 1304a acquires the current time clock and decides the time clock the next time the random music selection function can be invoked. Note that the method for deciding the invoking time clock is not particularly limited. For example, the invoking time clock may be decided to be a time clock after a predetermined period of time (e.g., 15 minutes) from the current time clock. Also, the time line may be separated, for example, by 15-minute intervals, so that an invoking time clock can be decided randomly by lottery in the time period (15 minutes) following the time period that includes the current time clock. Once an invoking time clock is decided, the music selection unit 1304a sets invoking time information indicating the decided invoking time clock (S3-9) and causes the player terminal 1 to receive the invoking time information. When the player terminal 1 receives the invoking time information, the invoking time clock is stored in the invoking-time information storage section 404.

Referring back to FIG. 10, upon receipt of the music selection information and the invoking time information, a presentation process (P5) is executed in the player terminal 1.

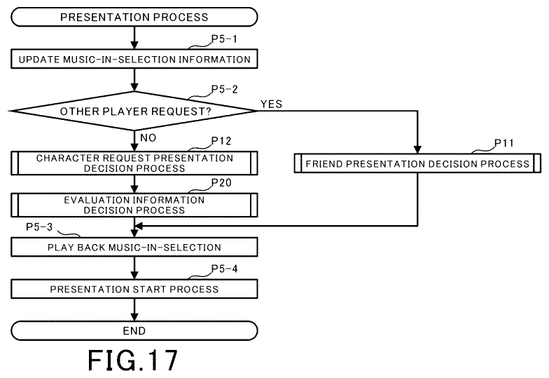

FIG. 17 is a flowchart for illustrating the presentation process in the player terminal 1. The presentation execution unit 310a updates the music-in-selection in the music-in-selection information storage section 400 on the basis of the received music selection information (P5-1). Then, if the request type is the other player request (YES in P5-2), the presentation execution unit 310a executes a friend presentation decision process (P11).

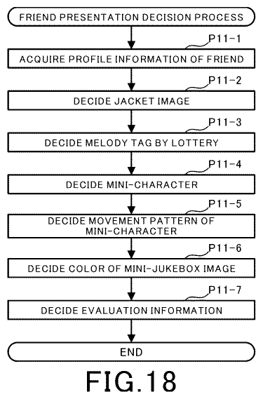

FIG. 18 is a flowchart for illustrating the friend presentation decision process in the player terminal 1. On the basis of the received music selection information, the presentation execution unit 310a acquires the profile information of the friend decided to be the requester (P11-1). Note that the profile information of the friend is stored in the friend information storage section 406 when the music selection information is received.

Also, the presentation execution unit 310a decides a jacket image 162 to be displayed on the jukebox image 152 and the music-in-selection information screen 180 on the basis of the music-in-selection information updated in P5-1 (P11-2). The presentation execution unit 310a also decides a melody tag tied to the music piece by lottery (P11-3).

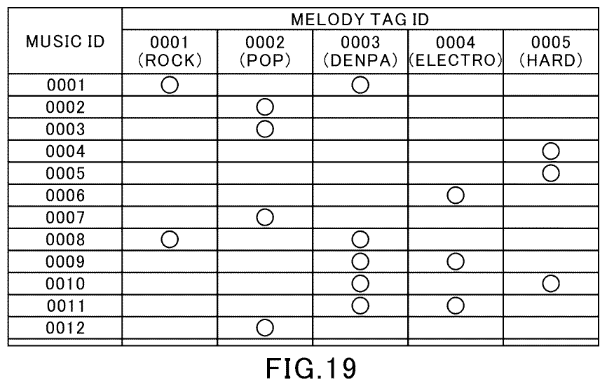

FIG. 19 is a drawing for illustrating melody tags. At least one melody tag (melody tag ID) is tied to each of all music pieces (music IDs) that can be played back by the jukebox function. A melody tag is information that indicates the melody of each music piece, and here, five kinds of melody tags are provided: rock (melody tag ID=0001), pop (melody tag ID=0002), denpa (melody tag ID=0003), electro (melody tag ID=0004), and hard (melody tag ID=0005). Melody tag information in which at least one melody tag ID is tied to each of the music IDs is stored in the player terminal 1 and the server 1000. According to the melody tag information, at least one melody tag ID is tied to each of the music IDs of the normal music pieces and the special music pieces.

Referring back to FIG. 18, the presentation execution unit 310a decides one melody tag in P11-3. More specifically, the presentation execution unit 310a extracts, on the basis of the melody tag information, at least one melody tag tied to the music-in-selection updated in P5-1 and generates a lottery table. Then, the presentation execution unit 310a decides one melody tag by lottery by using the generated lottery table. Therefore, if there is one melody tag tied to the music-in-selection, this melody tag is always decided.

Next, the presentation execution unit 310a decides a mini-character to be displayed on the requesting character image 154, the presentation image 162b, etc. (P11-4). Here, the presentation execution unit 310a decides that the representative character (which may also be the profile character) of the friend decided to be the requester is the mini-character.

The presentation execution unit 310a also decides a movement pattern of the mini-character decided in P11-4 (P11-5), and also decides a color of the mini-jukebox image 162c (P11-6).

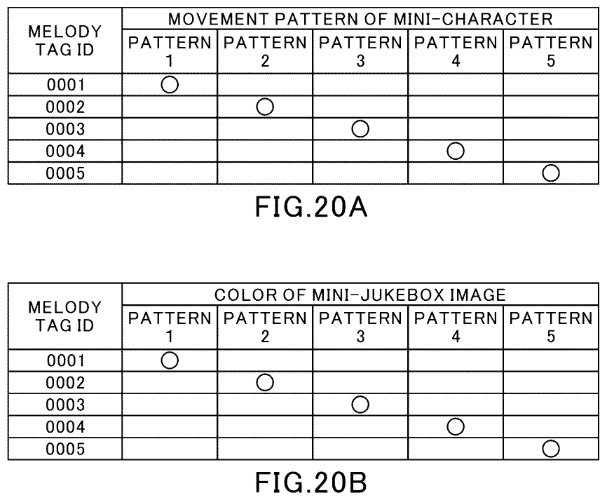

FIG. 20A is a drawing for illustrating the relationship between melody tags and movement patterns of the mini-character. Also, FIG. 20B is a drawing for illustrating the relationship between melody tags and the mini-jukebox image 162c. As shown in FIG. 20A, mini-character movement pattern information in which a movement pattern of the mini-character is tied to each melody tag ID is stored in the player terminal 1 and the server 1000. According to the mini-character movement pattern information, one movement pattern is tied to each melody tag ID.

Note that on the music-in-selection information screen 180, a presentation is given such that the mini-character displayed as the presentation image 162b moves in rhythm. The presentation execution unit 310a refers to the mini-character movement pattern information and decides a movement pattern of the mini-character on the basis of the previously decided melody tag. A movement pattern of the mini-character defines the behavior of the mini-character, and in this case, five different movement patterns are provided, from pattern 1 to pattern 5. By providing a movement pattern of the mini-character for each melody tag, the mini-character can be made to move in accordance with the music piece being played back.

As shown in FIG. 20B, display color pattern information in which a color of the mini-jukebox image 162c is tied to each melody tag ID is stored in the player terminal 1 and the server 1000. According to the display color pattern information, one display color is tied to each melody tag ID.

The presentation execution unit 310a refers to the display color pattern information and decides a color of the mini-jukebox image 162c on the basis of the previously decided melody tag. Here, five kinds of display colors are provided, from pattern 1 to pattern 5. By providing a display color of the mini-jukebox image 162c for each melody tag, the mini-jukebox image 162c can be displayed in a color that matches the music piece being played back.

Referring back to FIG. 18, the presentation execution unit 310a decides evaluation information, which is information concerning the evaluators and the number of evaluations (P11-7). Although described below in detail, evaluation information is decided when a player selects a favorite music piece and plays it back. The evaluation information decided at this time is stored in the server 1000 so as to be tied to the selected music piece. Thereafter, when the player is decided as the requester at the player terminal 1 of a friend of the player, the player terminal 1 of the friend receives, from the server 1000, the music piece last selected by the player and the evaluation information as music selection information. In P11-7, the evaluation information included in the received music selection information is decided to be the evaluation information to be displayed. Therefore, when the other-player-request function is invoked, the evaluation information displayed on the player terminal 1 is the same as that displayed on the player terminal 1 of the requester (friend).

Referring back to FIG. 17, if the request type is not the other player request (NO in P5-2), i.e., if the request type is the character request, the presentation execution unit 310a executes a character request presentation decision process (P12). In the character request presentation decision process, a requester (requesting character), a comment to be displayed in the comment display field of the presentation image 162b, a movement pattern of the mini-character, and a color of the mini-jukebox image 162c are decided.

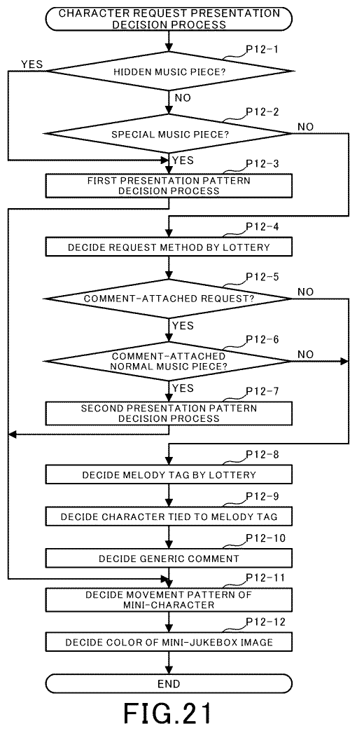

FIG. 21 is a flowchart for illustrating the character request presentation decision process in the player terminal 1. On the basis of the received music selection information, the presentation execution unit 310a determines whether or not the music piece decided by the server 1000 is a hidden music piece, i.e., whether or not a music piece in the unreleased status is decided (P12-1). Note that as in the server 1000, a status indicating the released status or the unreleased status is stored for each music piece in the released-music information storage section 412 of the player terminal 1.

Also, if the decided music piece is not a hidden music piece (NO in P12-1), the presentation execution unit 310a determines whether or not the decided music piece is a special music piece (P12-2). If the decided music piece is a hidden music piece (YES in P12-1) or a special music piece (YES in P12-2), the presentation execution unit 310a executes a first presentation pattern decision process (P12-3). In this first presentation pattern decision process, a requester (requesting character) and a comment to be displayed in the comment display field are decided.

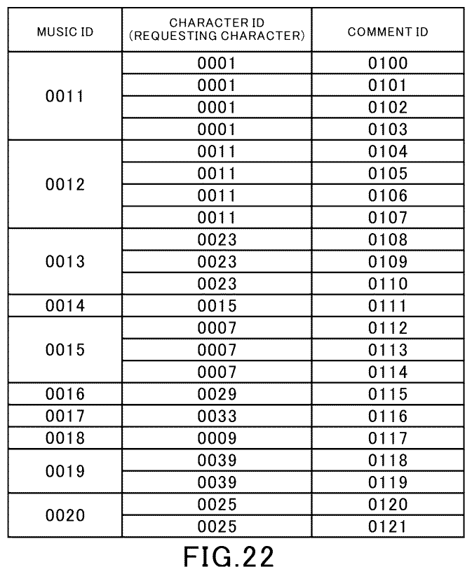

FIG. 22 is a drawing for illustrating the relationship among music IDs, character IDs, and comment IDs. First presentation information in which a character ID is tied to comment IDs for each of the music IDs of special music pieces is stored in the player terminal 1 and the server 1000. According to the first presentation information, at least one item of combination information composed of a character ID and a comment ID is tied to each of the music IDs of all special music pieces. Note that a character ID is identification information attached to each character, and a comment ID is identification information attached to each comment displayed in the comment display field.

In the first presentation pattern decision process (P12-3), one item of combination information is decided on the basis of the first presentation information. The character corresponding to the character ID included in the combination information decided at this time becomes the requester (requesting character). Also, the comment corresponding to the comment ID included in the decided combination information is displayed in the comment display field or on the requester details screen 220.

For example, four items of combination information are tied to a music ID=0011. If multiple items of combination information are tied to one music ID, the character IDs included in the items of combination information are common and the comment IDs are different from each other. That is, only one kind of character ID is tied to one special music piece. Therefore, the requesting character is fixed when a special music piece is selected by the random music selection function.

On the other hand, there are some music IDs each of which has different multiple comment IDs tied thereto. Thus, for example, if a music piece with a music ID=0011 is decided by the random music selection function, the mini-character with a character ID=0001 is always displayed on the music-in-selection information screen 180, but one of the four different comments is displayed in the comment display field.

Referring back to FIG. 21, if the decided music piece is neither a hidden music piece nor a special music piece (NO in P12-2), i.e., if a normal music piece is decided, then the presentation execution unit 310a decides a request method by lottery (P12-4). Note that the request method is a method for deciding a requester (requesting character) and a comment, and here, a comment-attached request and a tag request are provided.

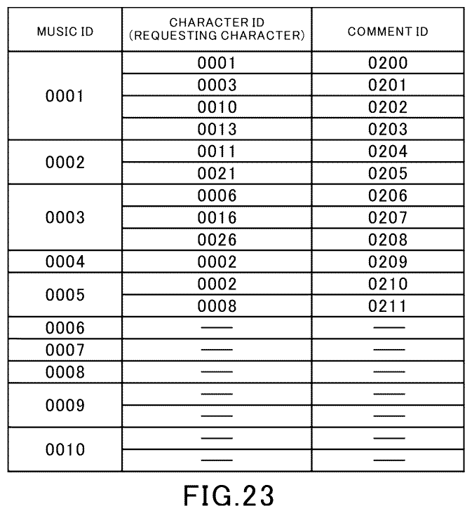

FIG. 23 is a drawing for illustrating comment-attached normal music pieces. Normal music pieces include comment-attached normal music pieces tied to characters that can serve as requesters (requesting characters) and to comments to be displayed in the comment display field. Here, as shown in FIG. 23, the normal music pieces with music IDs=0001 to 0005 are provided as comment-attached normal music pieces.

Second presentation information in which a character ID and a comment ID are tied to each of the music IDs of normal music pieces is stored in the player terminal 1 and the server 1000. According to the second presentation information, at least one combination pattern composed of the character ID of a character that can serve as a requester and the comment ID of a comment to be displayed in the comment display field is tied to each of the comment-attached normal music pieces. On the other hand, neither a character ID nor a comment ID is tied to the normal music pieces with music IDs=0006 to 0010. Hereinafter, normal music pieces to which neither a character ID nor a comment ID is tied are referred to as no-comment normal music pieces.

There are some comment-attached normal music pieces each having multiple combination patterns each composed of a character ID and a comment ID tied thereto. As described above, only one kind of character ID can be tied to a single special music piece. In contrast, there are some comment-attached normal music pieces in which multiple kinds of character IDs are tied to a single music ID. A comment tied to a comment-attached normal music piece is a comment exclusive to the music piece or the requesting character.

Referring back to FIG. 21, if the request method is decided to be the comment-attached request (YES in P12-5) and the decided music piece is a comment-attached normal music piece (YES in P12-6), then the presentation execution unit 310a executes a second presentation pattern decision process (P12-7). In this second presentation pattern decision process (P12-7), one item of combination information is decided on the basis of the second presentation information. The character corresponding to the character ID included in the combination information decided at this time becomes the requester (requesting character). The comment corresponding to the comment ID included in the decided combination information is displayed in the comment display field.

On the other hand, if the request method is decided to be the tag request (NO in P12-5) or the decided music piece is a no-comment normal music piece (NO in P12-6), then the presentation execution unit 310a decides a melody tag by lottery (P12-8).

As described above, melody tag information in which a melody tag ID is tied to each of the music IDs is stored in the player terminal 1 and server 1000 (see FIG. 19). In P12-8, the presentation execution unit 310a decides one melody tag in the same manner as in P11-3. More specifically, the presentation execution unit 310a extracts at least one melody tag tied to the music-in-selection updated in P5-1 on the basis of the melody tag information and generates a lottery table. Then, one melody tag is decided by lottery by using the generated lottery table.

Next, the presentation execution unit 310a decides a requesting character on the basis of the melody tag decided in P12-8 (P12-9).

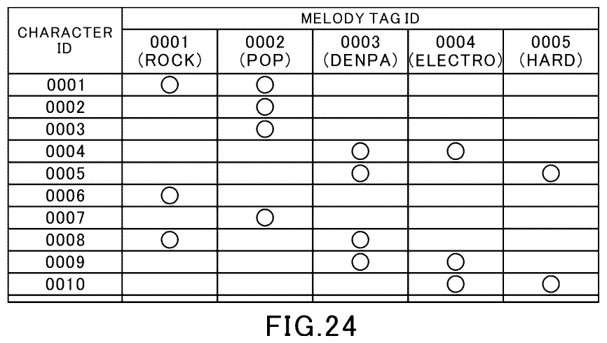

FIG. 24 is a drawing for illustrating character-specific melody tag information. Character-specific melody tag information in which a melody tag ID is tied to each character ID is stored in the player terminal 1 and the server 1000. According to the character-specific melody tag information, at least one melody tag ID is tied to each character ID.

Referring back to FIG. 21, in P12-9, the presentation execution unit 310a extracts all character IDs to which the melody tag decided in P12-8 is tied on the basis of the character-specific melody tag information. Then, the presentation execution unit 310a decides any one of the extracted character IDs. The character corresponding to the character ID decided at this time becomes the requester (requesting character).

The presentation execution unit 310a also decides a generic comment prepared in advance as the comment to be displayed in the comment display field (P12-10).

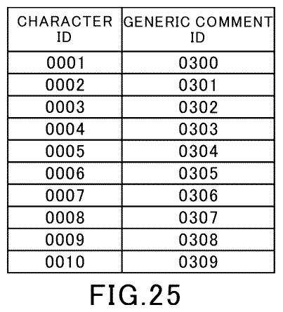

FIG. 25 is a drawing for illustrating generic comment information. Generic comment information in which a generic comment ID is tied to each character ID is stored in the player terminal 1 and the server 1000. One generic comment that is displayed in the comment display field is always tied to each character. A generic comment is assigned a generic comment ID, and one generic comment ID is tied to each character ID in the generic comment information.

Referring back to FIG. 21, in P12-10, the presentation execution unit 310a decides one generic comment on the basis of the generic comment information. More specifically, the presentation execution unit 310a decides the generic comment tied to the requesting character decided in P12-9 on the basis of the generic comment information.

When a requesting character and a comment to be displayed in the comment display field are decided in P12-3, P12-7, P12-9, and P12-10 as described above, the presentation execution unit 310a decides a movement pattern of the mini-character (P12-11) and also decides a color of the mini-jukebox image 162c (P12-12). Note that the processes in P12-11 and P12-12 are the same as those in P11-5 and P11-6 in the friend presentation decision process.

Referring back to FIG. 17, when a requesting character, a comment, a movement pattern of the mini-character, and a color of the mini-jukebox image 162c are decided in the character request presentation decision process (P12), the presentation execution unit 310a executes an evaluation information decision process (P20). In this evaluation information decision process, evaluation information such as the number of evaluations and evaluators (evaluation characters) is decided.

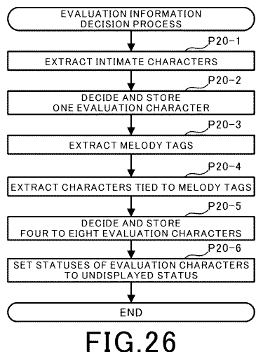

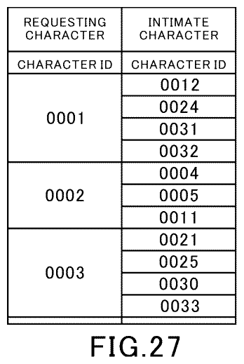

FIG. 26 is a flowchart for illustrating the evaluation information decision process in the player terminal 1. Furthermore, FIG. 27 is a drawing for illustrating character correlation information. Character correlation information is stored in the player terminal 1 and the server 1000. The presentation execution unit 310a extracts intimate characters on the basis of the character correlation information (P20-1).

More specifically, according to the character correlation information, a plurality of characters are tied as intimate characters to one character, as shown in FIG. 27. In P20-1, the presentation execution unit 310a extracts the intimate characters tied to the previously decided requesting character on the basis of the character correlation information. As shown in FIG. 26, the presentation execution unit 310a also generates a lottery table based on the extracted intimate characters and decides one of the extracted intimate characters to be an evaluation character by using the generated lottery table (P20-2). Also here, the decided evaluation character is stored in the evaluation information storage section 402.

Also, the presentation execution unit 310a extracts the melody tags tied to the music-in-selection on the basis of the melody tag information (P20-3). In addition, the presentation execution unit 310a extracts all characters to which the melody tags extracted in P20-3 are tied on the basis of the character-specific melody tag information (P20-4). Then, the presentation execution unit 310a decides that four to eight characters from among all extracted characters, excluding the requesting character, are evaluation characters (P20-5). Here, the decided evaluation characters are also stored in the evaluation information storage section 402.

Note that in P20-5, no specific processes for deciding an evaluation character are particularly limited. For example, the number of evaluation characters may be decided first, and then the evaluation characters may be decided. Alternatively, it may be decided by lottery whether or not each of the extracted characters should be set as an evaluation character, until the number of evaluation characters reaches the maximum number.

Then, the presentation execution unit 310a sets the statuses of the evaluation characters stored in the evaluation information storage section 402 in P20-2 and P20-5 to the undisplayed status (P20-6). Note that the evaluation information is not displayed at the time the evaluation characters are decided, i.e., at the time the random music selection function is invoked and playback of the music piece is started. Thereafter, once the screen transitions from the top screen to the nurturing game screen or the like after the playback of the music piece has started and then back to the top screen again, the number of evaluations and the evaluators (evaluation characters) are updated and displayed.

More specifically, when the screen transitions from the top screen to the nurturing game screen or the like after the playback of the music piece has started and then back to the top screen again, the top screen transition process (P4) shown in FIG. 12 is executed. In this top screen transition process, the evaluation information update process (P10) shown in FIG. 13 is executed. At this time, because there are evaluators (evaluation characters) whose statuses are the undisplayed status in the evaluation information storage section 402, the evaluators (evaluation characters) and the number of evaluations are updated in P10-2.

Referring back to FIG. 17, when a requester (mini-character), a comment, and evaluation information are decided in P11, P12, and P20, the presentation execution unit 310a starts playback of the music-in-selection (P5-3). Also, the presentation execution unit 310a starts various kinds of presentations (P5-4). Here, for example, highlighting of the notification icon 144R on the home screen 100, as well as display of the jukebox icon 210, the jukebox image 152, the requesting character image 154, etc., are started.

Thus, when the random music selection function is invoked, a music piece to be played back is decided in the server 1000, and various presentations are given during the playback of the music piece in the player terminal 1.

Next, the processes of the player terminal 1 executed when the player selects a favorite music piece by means of the jukebox function is described.

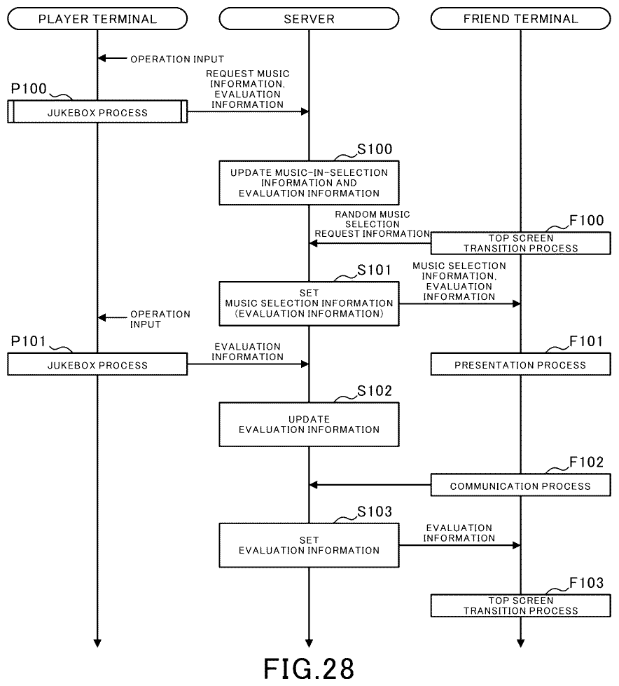

FIG. 28 is a sequence diagram for illustrating processes executed in the player terminal 1 and the server 1000 when the player selects a music piece to be played back. When an operation input related to the jukebox function is made on the player terminal 1, the presentation execution unit 310a executes a jukebox process (P100).

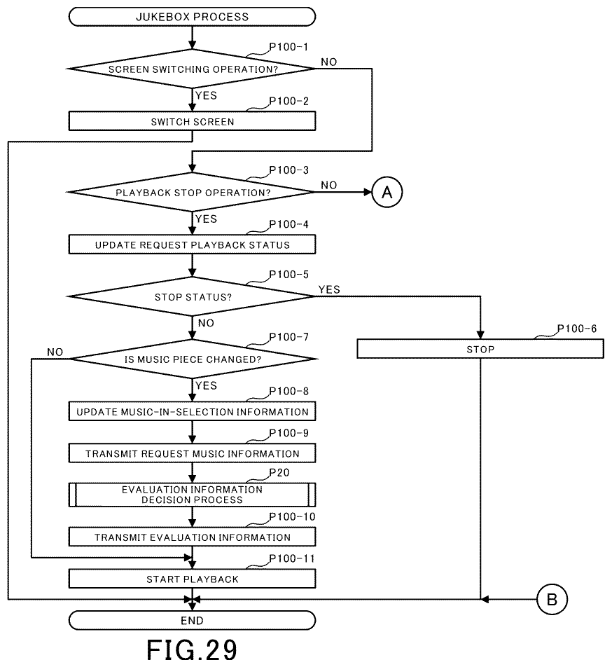

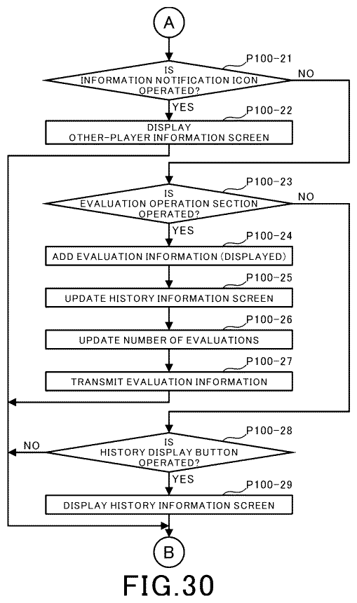

FIG. 29 is a first flowchart for illustrating the jukebox process in the player terminal 1. Also, FIG. 30 is a second flowchart for illustrating the jukebox process in the player terminal 1. If a screen switching operation for switching the screen is input as an operation related to the jukebox function (YES in P100-1), the presentation execution unit 310a switches the screen according to the input operation (P100-2).

Also, if a playback stop operation is input (YES in P100-3), the presentation execution unit 310a updates the request playback status stored in the request playback status storage section 410 (P100-4). Note that the playback stop operation is an operation input to the request operation section 170 or the playback stop button 188. The presentation execution unit 310a updates the request playback status to the stop status if it is the playback-in-progress status and to the playback-in-progress status if it is the stop status.

If the request playback status is updated to the stop status in P100-4 (YES in P100-5), the presentation execution unit 310a stops playback of the music piece (P100-6). Note that if the request operation section 170 is operated to stop playback of the music piece, the music-in-selection information is deleted from the music-in-selection information storage section 400 in P100-6. Also in this case, the presentation execution unit 310a starts playback of the default BGM. It should be noted, however, that the music-in-selection information may be retained even if the request operation section 170 is operated during playback of the music piece.

On the other hand, if the request playback status is updated to the playback-in-progress status in P100-4 (NO in P100-5), it is determined whether or not the music piece selected by the player is changed from the music-in-selection (P100-7). If the music piece is not changed (NO in P100-7), the presentation execution unit 310a starts playback of the music-in-selection (P100-11).

Also, if the music-in-selection is changed (YES in P100-7), i.e., if the request operation section 170 is operated in a state in which a different music piece from the music-in-selection is newly selected on the music selection screen 160, the presentation execution unit 310a updates the music-in-selection information in the music-in-selection information storage section 400 (P100-8). Also, the transmission/reception unit 300a transmits, to the server 1000, request music information indicating the music-in-selection selected by the player (P100-9).

In addition, the presentation execution unit 310a executes the evaluation information decision process (P20) shown in FIG. 26 on the basis of the music-in-selection. Then, the transmission/reception unit 300a transmits the evaluation information decided in the evaluation information decision process to the server 1000 (P100-10) and starts playback of the changed music piece (P100-11).

Thus, when the player selects and plays back a music piece by himself/herself using the jukebox function, the music piece selected by the player and the evaluation information decided in the player terminal 1 are transmitted to the server 1000. At the server 1000, the request music information and the evaluation information are stored so as to be tied to the player ID.

Note that when the random music selection function is invoked and a music piece decided by the server 1000 is played back, the decided music piece and evaluation information are not stored in the server 1000. That is, only a music piece selected by the player himself/herself and the evaluation information decided at the time the music piece is selected are stored in the server 1000.

Moreover, as shown in FIG. 30, if the information notification icon 184c is operated (YES in P100-21), the presentation execution unit 310a displays the other-player information screen (P100-22). As described above, information concerning the other player who has requested the music piece being played back is displayed on the other-player information screen.

In addition, if the evaluation operation section 184a is operated (YES in P100-23), the presentation execution unit 310a stores information identifying an evaluator in the evaluation information storage section 402 (P100-24). Here, the profile character of the player is added as an evaluator and the status is stored as the displayed status.

Then, the presentation execution unit 310a updates the history information screen 200 on the basis of the evaluation information storage section 402 updated in P100-24 (P100-25). Furthermore, the presentation execution unit 310a updates the number of evaluations displayed in the evaluation information display field 184 (P100-26). The transmission/reception unit 300a also transmits the evaluation information updated in P100-24 to the server 1000. Because of this, the fact that the player has made an evaluation of the music piece selected by the player himself/herself is saved in the server 1000.

In addition, if the history display button 184b is operated (YES in P100-28), the presentation execution unit 310a displays the history information screen 200 related to the music-in-selection (P100-29).

Referring back to FIG. 28, when the request music information and the evaluation information are transmitted to the server 1000 in the jukebox process (P100) of the player terminal 1, the music-in-selection information that is saved in the selected-music information storage section 1402 and that is tied to the player ID and the evaluation information are updated in the server 1000 (S100). Also, in the server 1000, the music-in-selection information and the evaluation information are updated in the player information storage section 1400 provided for each player.

It is assumed that thereinafter, the top screen transition process (F100) is executed in the player terminal 1 of the friend (hereinafter, referred to as the friend terminal) of the player whose music-in-selection information was updated in S100, and the random music selection request information is transmitted to the server 1000. At the server 1000, the music selection process (S101) is executed, and a music piece to be played back on the friend terminal is decided. At the friend terminal, when the music selection information and evaluation information are received, the presentation process (F101) is executed, and the music piece decided by the server 1000 is played back.

It is assumed that at this time, the music piece selected by the player in P100 shown in FIG. 28 is played back in the presentation process of the friend terminal. In this case, on the evaluation history information screen 200a of the friend terminal, the same evaluation information as that displayed on the evaluation history information screen 200a of the player terminal 1 is displayed.

It is assumed that thereafter, the jukebox process (P101) is executed again in the player terminal 1, and the player evaluates the music piece selected by himself/herself. In this case, evaluation information is transmitted from the player terminal 1 to the server 1000, and the evaluation information is updated in the server 1000 (S102).

Thereafter, when a communication process (F102) is executed between the friend terminal and the server 1000, the evaluation information updated in S102 is set in the server 1000 (S103). At the friend terminal, when the top screen transition process (F103) is executed after this evaluation information has been received, the updated evaluation information is displayed. That is, in F103, information concerning the evaluation made by the player in P101 can be displayed.

Note that after this, when the friend evaluates the music piece being played at the friend terminal, this evaluation information is stored in the server 1000. Thereafter, when a communication process is executed between the player terminal 1 and the server 1000, the player terminal 1 receives the updated evaluation information. Also, when the top screen transition process is executed in the player terminal 1 thereafter, the added evaluation information is displayed. This gives the impression that music selection made by the player himself/herself has been evaluated by another player, which can improve the player's motivation to play the game.

Although an aspect of an embodiment has been described with reference to the accompanying drawings, it goes without saying that the present invention is not limited to the aforementioned embodiment. It would be obvious that a person skilled in the art could conceive of various modifications and amendments within the scope recited in the claims, and it will be understood that those modifications and amendments obviously belong to the technical scope.

Although the aforementioned embodiment has been described by way of an example where the game genre is a nurturing game, the game genre and gameplay are not particularly limited.

Furthermore, the aforementioned embodiment has been described by way of an example where a music piece is played back as content by the jukebox function. It should be noted, however, that content is not limited to a music piece. For example, a plurality of movies or static images may be provided as content, so that these items of content can be selected by the player himself/herself or the aforementioned random music selection function.

In the aforementioned embodiment, the random music selection function and the other-player-request function are provided. That is, in the aforementioned embodiment, the process for deciding content includes the process for deciding one item of content by lottery, irrespective of a player operation input. It should be noted, however, that the random music selection function and the other-player-request function are not essential.

Furthermore, in the aforementioned embodiment, the process for causing the player to select one item of content from a plurality of kinds of content and the process for playing back the content selected by the player are executed. It should be noted, however, that the function for causing the player to select and play back a favorite music piece is not essential, and a music piece may be selected only by the random selection function and the other-player-request function.

In any case, it suffices if the process for deciding one item of content from a plurality of kinds of content and the process for playing back the decided content are executed, and the method of deciding content is not particularly limited.

Furthermore, the aforementioned embodiment has been described by way of an example where the player terminal 1 acquires information concerning a music piece selected by another player as other-player information for playing back the music piece by means of the other-player-request function. More specifically, the process for enabling selection information indicating content selected by the player to be transmitted to another player is executed, the other-player information includes selection information of another player, and content selected by another player is decided on the basis of the selection information.

It should be noted, however, that the other-player information required to play back a music piece by the other-player-request function is not limited to this. For example, the fact that another player has displayed a predetermined story image, the fact that another player has cleared a predetermined game, or the like may be acquired as other-player information, and any content may be played back on the basis of these items of acquired other-player information.

In any case, it suffices if the process for achieving the other-player-request function includes: the process for acquiring other-player information, which is information concerning game play of another player; the process for deciding one item of content from a plurality of kinds of content on the basis of the acquired other-player information; and the process for playing back the decided content. Thus, the content of the other-player information and the correlation between the other-player information and the decided content are not particularly limited.

Also, the aforementioned embodiment has been described by way of an example where it is possible to switch between a permitted status (on status of the other-player-request function), which permits playback of content decided on the basis of other-player information, and a non-permitted status (off status of the other-player-request function), which does not permit playback of content decided on the basis of other-player information, so that content decided on the basis of other-player information is played back on condition that the permitted status is set. It should be noted, however, that switching between the permitted status and the non-permitted status is not essential, and the other-player-request function may be always permitted.

Also, in the aforementioned embodiment, only players registered as friends can be requesters using the other-player-request function. It should be noted, however, that players who can be requesters are not limited to friends. For example, it is acceptable that all players can be requesters, or players who meet predetermined conditions can be requesters.

In addition, in the aforementioned embodiment, during playback of a music piece and in a state in which a music piece to be played back has been decided, a mini character, a comment, a mini-jukebox image 162c, a requesting character image 154, and a jukebox image 152 are displayed as objects associated with the music piece being played back or to be played back. Also, in the aforementioned embodiment, the objects are characters, and the display modes (behavior) of the characters differ depending on the display pattern. It should be noted, however, that an object that is associated with the music piece to be played back is not particularly limited. In any case, it suffices if the process for deciding a display pattern for an object associated with the content to be played back and the process for displaying the object in the decided display pattern at least either during playback of content or in a state in which the content to be played back has been decided are executed.

Moreover, mini-characters, etc. in the aforementioned embodiment may be displayed only during playback of content or may be displayed in a state in which content to be played back is decided and playback of the content is stopped.

Furthermore, in the aforementioned embodiment, the player can evaluate the content to be played back. Also, the process for making evaluation information indicating the player's evaluation of content communicable to another player, the process for acquiring evaluation information of another player, and the process for displaying the acquired evaluation information are executed. It should be noted, however, that the aforementioned evaluation function is not essential.

In addition, in the aforementioned embodiment, when a music piece is selected by the other-player-request function, information concerning another player who is the requester can be displayed, but the information concerning the other player to be displayed at this time is not particularly limited. In any case, it suffices if some information concerning the other player is displayed. Display of information concerning another player is not essential, and the timing at which information concerning another player is displayed is not particularly limited. In any case, the process for enabling display of information concerning another player may be executed at least either during playback of content or in a state in which content to be played back has been decided.

Furthermore, the aforementioned embodiment has been described by way of an example where music selection is executed at the server 1000 when the random music selection function and the other-player-request function are invoked, and presentation of a mini-character, etc. displayed on the player terminal 1 is decided at the player terminal 1. It should be noted, however, that music selection and presentation may be all decided at the server 1000. Alternatively, music selection and presentation may be all decided at the player terminal 1. Furthermore, music selection may be executed at the player terminal 1, and presentation may be decided at the server 1000. In any case, the processes of the player terminal 1 and the server 1000 in the aforementioned embodiment are merely examples, and how to divide roles of each process is not particularly limited.

Note that the information processing programs for executing the processes in the aforementioned embodiment and various kinds of modifications may be stored in a computer-readable, non-transitory storage medium, and may be provided in the form of a storage medium. Furthermore, a game terminal device including this storage medium may be provided. The aforementioned embodiment and various kinds of modifications may also be an information processing method that realizes each function and the steps shown in the flowcharts.

What is claimed is:

1. A non-transitory computer readable medium storing a program causing a computer to execute:
a process for deciding one item of content from a plurality of kinds of content;
a process for playing back the decided content;
a process for deciding a display pattern of an object associated with the content that is played back; and
a process for displaying the object in the decided display pattern at least one of during playback of the content and in a state in which the content that is played back is decided.

2. The non-transitory computer readable medium according to claim 1,
wherein the process for deciding one item of content includes a process for deciding the one item of content by lottery regardless of an operation input made by a player.

3. The non-transitory computer readable medium according to claim 2,
wherein the object is a character, and
a display mode of the character differs depending on the decided display pattern.

4. The non-transitory computer readable medium according to claim 1, wherein the program causes the computer to further execute:
a process for enabling a player to evaluate the content that is played back.

5. An information processing method executed by a computer, the method comprising:
a process for deciding one item of content from a plurality of kinds of content;
a process for playing back the decided content;
a process for deciding a display pattern of an object associated with the content that is played back; and
a process for displaying the object in the decided display pattern at least one of during playback of the content and in a state in which the content that is played back is decided.

6. An information processing system comprising at least one computer, wherein the at least one computer executes:
a process for deciding one item of content from a plurality of kinds of content;
a process for playing back the decided content;
a process for deciding a display pattern of an object associated with the content that is played back; and
a process for displaying the object in the decided display pattern at least one of during playback of the content and in a state in which the content that is played back is decided.
